(19) United States
(12) Patent Application Publication
(10) Pub. No.: US 2019/0156450 A1
(43) Pub. Date: May 23, 2019

(54) Systems and Methods for Monitoring and Managing Marine Riser Assets

(71) Applicant: Kaustubh V. DIGHE, Houston, TX (US)

(72) Inventor: Kaustubh V. DIGHE, Houston, TX (US)

(21) Appl. No.: 16/099,686

(22) PCT Filed: May 30, 2017
(86) PCT No.: PCT/US2017/035042

§ 371 Date: Nov. 7, 2018

Related U.S. Application Data
(60) Provisional application No. 62/342,879, filed on May 28, 2016.
(60) Provisional application No. 62/342,881, filed on May 28, 2016.

(51) Int. Cl. G06Q 50/26; E21B 17/01; E21B 47/00; G01N 17/00; G06Q 10/10; G06Q 10/00

(52) U.S. Cl. CPC G06Q 50/265; E21B 17/01; G06Q 10/20; G01N 17/006; G06Q 10/1097; E21B 47/00

(57) ABSTRACT

A method for inspecting a riser asset of a marine riser includes generating a first predictive degradation rate of a first potential flaw in the riser asset based on an engineering assessment. The method also includes receiving, from sensors, sensor data indicative of a first flaw corresponding with the first potential flaw. The method also includes generating a first actual degradation rate of the first flaw based on the sensor data. The method also includes determining a first remaining operating lifetime of the riser asset based on the first predictive degradation rate and the first actual degradation rate. The method also includes determining a first inspection frequency for the riser asset based on a first safety factor and the first remaining operating lifetime of the riser asset. The method also includes generating a first inspection timeline based on the first inspection frequency.

### CROSS-REFERENCE TO RELATED APPLICATIONS

This application is a 35 U.S.C. § 371 national stage application of PCT/US2017/035042 filed May 30, 2017, and entitled “Systems and Methods for Monitoring and Managing Marine Riser Assets,” which claims benefit of U.S. provisional patent application Ser. No. 62/342,879 filed May 28, 2016, and entitled “Method for Monitoring and Managing Marine Riser Assets”, and U.S. provisional patent application Ser. No. 62/342,881 filed May 28, 2016, and entitled “System for Monitoring and Managing Marine Riser Assets,” each of which is hereby incorporated herein by reference in its entirety for all purposes.

### STATEMENT REGARDING FEDERALLY SPONSORED RESEARCH OR DEVELOPMENT

Not applicable.

### BACKGROUND

The present disclosure generally relates to systems and methods for managing the integrity of marine riser assets. More specifically, the present disclosure relates to systems and methods for monitoring marine riser assets, determining the frequency of inspections of mariner riser assets, and identifying and scheduling remedial actions for marine riser assets.

In offshore drilling operations, a primary conductor is run into a relatively large diameter borehole drilled in the sea bed. Cement is pumped down the primary conductor and allowed to flow back up the annulus between the primary conductor and the borehole sidewall to secure the primary conductor in position. Next, a drill bit connected to the lower end of a drillstring suspended from a drilling vessel at the sea surface is lowered through the primary conductor to further drill the borehole. Strings of casing are run through the primary conductor and into the borehole. Cement then is pumped down the casing string, and allowed to flow back up the annulus between the casing string and the primary conductor to secure the casing string in place. Before continuing drilling to further depths, a blowout preventer (BOP) is mounted to a wellhead disposed at the upper ends of the casing string and the primary conductor, and a lower marine riser package (LMRP) is mounted to the BOP. In addition, a marine drilling riser string extends from the upper end of the LMRP to the drilling vessel or rig at the surface. The drill string with the drill bit disposed at a lower end is suspended from the rig through the drilling riser, LMRP, and BOP into the wellbore. Drilling continues while successively installing concentric casing strings through the marine drilling riser string and previously installed casing strings to line the borehole. Each successive casing string is cemented in place by pumping cement down the casing and allowing it to flow back up the annulus between the casing string and the borehole sidewall. While drilling, drilling fluid or mud is pumped down the drillstring and out the face of the drill bit into the borehole. The drilling fluid returns to the surface via a first annulus between the drill string and casing and a second annulus between the drillstring and the marine drilling riser.

Marine risers are subjected to various dynamic loads during transport, installation, drilling operations, and retrieval. For example, during drilling operations, the mariner riser may experience dynamic tensile loads, torsional loads, and cyclical bending loads since its lower end is connected to the stationary BOP and its upper end is connected to the floating drilling vessel or rig. In addition, the marine riser may experience lateral loads applied by subsea currents and surface waves. During transport, installation subsea, retrieval, drilling operations, or combinations thereof, the marine riser may be inadvertently impacted by other equipment or hardware. The marine riser also experiences internal fluid pressures applied by the drilling mud flowing therethrough and external fluid pressures applied by the surrounding ocean. The abrasive and corrosive drilling fluid inside the marine riser and the corrosive salt water outside the marine riser may also induce erosion and/or corrosion along the inner and outer surfaces of the marine riser.

### BRIEF SUMMARY OF THE DISCLOSURE

In accordance with at least one embodiment of the invention, a computer program product for generating an inspection timeline for a riser asset of a marine riser includes a computer readable storage medium having program instructions embodied therewith. The program instructions are executable by a computer to cause the computer to: receive a first predictive degradation rate of a first potential flaw in the riser asset, receive a first actual degradation rate of a first flaw in the riser asset, determine a first remaining operating lifetime of the riser asset based on the first predictive degradation rate and the first actual degradation rate, determine an inspection frequency for the riser asset based on a safety factor and the first remaining operating lifetime of the riser asset, and generate the inspection timeline based on the inspection frequency. The first flaw corresponding with the first potential flaw.

Another illustrative embodiment is a method for inspecting a riser asset of a marine riser includes generating a first predictive degradation rate of a first potential flaw in the riser asset based on an engineering assessment. The method also includes receiving, from sensors, sensor data indicative of a first flaw corresponding with the first potential flaw. The method also includes generating a first actual degradation rate of the first flaw based on the sensor data. The method also includes determining a first remaining operating lifetime of the riser asset based on the first predictive degradation rate and the first actual degradation rate. The method also includes determining a first inspection frequency for the riser asset based on a first safety factor and the first remaining operating lifetime of the riser asset. The method also includes generating a first inspection timeline based on the first inspection frequency.

Yet another illustrative embodiment is a marine riser inspection system that includes a riser asset and an operational assessment module. The operational assessment module is configured to: receive a first predictive degradation rate of a first potential flaw in the riser asset, receive a first actual degradation rate of a first flaw in the riser asset, determine a first remaining operating lifetime of the riser asset based on the first predictive degradation rate and the first actual degradation rate, determine an inspection frequency for the riser asset based on a safety factor and the first remaining operating lifetime of the riser asset, and generate the inspection timeline based on the inspection frequency. The first flaw corresponds with the first potential flaw.

Embodiments described herein comprise a combination of features and advantages intended to address various shortcomings associated with certain prior devices, systems, and methods. The foregoing has outlined rather broadly the features and technical advantages of the invention in order that the detailed description of the invention that follows may be better understood. The various characteristics described above, as well as other features, will be readily apparent to those skilled in the art upon reading the following detailed description, and by referring to the accompanying drawings. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 is a schematic view of a marine riser;

FIG. 2 is a side view of a marine riser asset;

FIGS. 3a and 3b illustrate an embodiment of a system in accordance with the principles described herein for monitoring marine riser assets and managing the remaining operating lifetime of the marine riser assets;

FIGS. 4a-4c depict a data storage usable to implement the method according to one or more embodiments;

FIG. 5 depicts types of inspections of a marine riser asset according to one or more embodiments;

FIG. 6 depicts a system with a network in communication with a processor and a data storage according to one or more embodiments;

FIGS. 7a and 7b depict remaining operating lifetimes for two different marine riser assets according to one or more embodiments; and

FIGS. 9a-9e depicts a user customizable review according to one or more embodiments.

### DETAILED DESCRIPTION OF THE PREFERRED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

The terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections.

The term “alarms” as used herein can be one or a group of emails, text messages, audio signals, vibration patterns, phone calls, or other notifications, which indicate when an operating condition or a physical inspection of the marine riser asset has fallen below or exceeded “key performance indicators”.

The term “anomaly” as used herein can be a flaw that requires monitoring and optionally repair, but does not necessarily impair operation of the marine riser asset.

The term “anticipated operating parameters” as used herein can refer to the expected operating conditions for a specific marine riser asset including but not limited to the entire operating life of the marine riser asset and all the years between install and removal.

The term “baseline condition” as used herein can refer to the measurement of the various dimensions, the non-destructive testing inspection of the riser, and the recording of physical observations of the marine riser asset at a point in time in order to create a datum against in which predictive measurements and observations can be compared.

The term “critical” as used herein can refer to a high likelihood of failure, a severe consequence if failures occur, or a combination of high likelihood of failure and a severe consequence. When used to describe components, the term “critical” can indicate that the component is considered to have a history of failure, the consequence of such failure is severe or the component has a combination of high likelihood of failure with severe consequences. When used to describe threats, the term “critical” can indicate that the threat has a high likelihood of occurrence, a severe consequence or a combination of a high likelihood and a severe consequence.

The term “customized units of time” as used herein can refer to units of time between inspections of marine riser assets, which can be created using the Operational Assessment Module and recorded in the marine tracking model, which can vary based on operating conditions.

The term “degradation rate” as used herein can refer to how fast the condition of the marine riser asset deteriorates, such as a crack growth rate or a corrosion rate for a marine riser asset.

The term “engineering assessment” as used herein can refer to the study of the marine riser asset or any of its components, applying theories of engineering to determine the theoretical rate of deterioration of the marine riser asset or its components and the points of mechanical failure of the marine riser asset when subjected to a set of operating conditions.

The term “fit for use” as used herein can refer to the marine riser asset being considered suitable to reliably and safely perform its intended function and operation.

The term “flaw” as used herein can refer to a crack, a fracture, a bubble, a pit, a tear, a score, a gouge or other discontinuity in the structure of the marine riser, which is a defect in the marine riser asset but does not necessarily impair operation of the marine riser asset or require monitoring of the flaw, or the repair of the flaw.

The term “historic degradation rate” as used herein can refer to the rate at which a certain dimension of the marine riser asset has actually reduced in size, or a flaw or anomaly in the structure has actually increased in size over a period of time that has already passed.

The term “induction” as used herein can refer to the initial phase of recognizing and adding a marine riser asset to the marine riser asset tracking model, which includes a sequence of activities for a plurality of marine riser assets. The sequence can include collecting design data, manufacturing data, dimension data, rig identifiers, geographic locations of a rig or rigs, service history, certification, and collecting anticipated sea states, such as currents, wave heights, and for the zones of water depth that the marine riser asset will operate in.

The term “physical inspection” as used herein can refer to an examination of the marine riser asset performed visually or by using electronic, ultrasonic or acoustic tools, and the recording of the dimensions and flaws or anomalies in the structure of the marine riser asset.

The term “key performance indicators” as used herein can refer to an important variable in the calculation of the remaining operating lifetime, where a small change in the value of the variable can have a significant effect on the remaining operating lifetime of the marine riser asset and where the increase or decrease in the value of the variable beyond a certain point may cause the marine riser asset to degrade at a rate faster or slower than the anticipated degradation rate.

The term “lookup tables of degradation rates” as used herein can refer to a table of results. For example, a lookup table may include a collection of results from the engineering assessment of how fast the marine riser asset and its components will degrade, wherein a variety of results have been obtained in response to systematically organize deliberate variations of the anticipated operating conditions subjected to the marine riser asset.

The term “machine readable identifier” as used herein can refer to a storage medium affixed to the marine riser asset that stores a unique pattern of lines, dots or a combination thereof, inscribed on its surface such that it can be read by a photo conative machine, or a series of alphanumeric characters stored within the medium that can be interrogated by an electronic signal transmitted and received by a machine. In embodiments, the machine readable identifier can be a radio frequency identification “RFID” tag or chip, or a quick response “QR” code.

The term “marine riser asset tracking model” as used herein can refer to the collection of design data, manufacturing data, operating data, dimension measurements, digital images both photographic and video graphic, non-destructive testing inspection results, record of certification, estimates of remaining operating lifetime, details of ownership and assignment, service history, records of historic physical inspection, records of deployment of the riser, record of zone of water depth information for a single or a plurality of marine riser assets and records of technical assessments on the condition of the marine riser asset held within an digital data storage connected to a processor, governed by a variety of procedures and routines that harness the computational power of the processor to produce a database of the collection of flaws and anomalies, an estimate of remaining operating lifetime, an estimate of predictive physical inspection requirements, a list of anomalies, a written certificate and reports for a single or a plurality of marine riser assets.

The term “non-destructive testing inspection” as used herein can refer to testing using techniques that can include magnetic particle physical inspection, ultrasonic testing, time of flight diffraction, phased array or gamma x-ray.

The term “operating abnormalities” as used herein can refer to a condition that is outside planned activities or anticipated sea states, currents, wave heights around the rig, the operating conditions, and zones of water depth that the rig will operate in.

The term “operating condition” as used herein can refer to conditions in which the marine riser asset is exposed to when in it is performing its intended function. The operating condition can include, fluid weight of fluid passing through the marine riser asset, tension applied to the marine riser asset, bending moment applied to the marine riser asset, torque applied to the marine riser asset, fluid chemistry of the fluid passing through the marine riser asset, pressure of the fluid within the marine riser asset and temperature of the fluid within the marine riser asset and angle of inclination of the marine riser asset. Additionally, the operation conditions can include, current, wave height, water temperature, air temperature and water depth around the marine riser asset.

The term “operating modes” as used herein can refer to the combination of the functions the marine riser asset is performing and location of the marine riser at a particular time.

The term “predictive degradation rate” as used herein can refer to the speed at which the marine riser asset is expected to degrade in condition through change in physical dimension or through growth of a flaw or anomaly over a period on time.

The term “updated baseline physical inspection” as used herein can refer to a physical inspection conducted after the initial baseline physical inspection that includes the measurement of the various dimensions and the recording of physical observations, and non-destructive testing inspection results of the marine riser asset to set a new datum against which predictive and past measurements and observations can be compared. In embodiments, the updated baseline can comprise no change, at least one flaw, at least one anomaly, a plurality of anomalies, a plurality of flaws, and combinations thereof.

The term “remaining operating lifetime” as used herein can refer to the period of time, starting from the moment of assessment, through a period of time the marine riser asset continues to reliably and safely perform its intended function and operation or to the point in time it is anticipated to fail to the point in time the marine riser asset can reliably and safely perform its intended function and operation.

The term “risk assessment” as used herein can refer to a study performed by a group of subject matter experts who have knowledge of the likelihood of failure and consequence of failure of marine riser assets for a selection of threats. The subject matter experts' knowledge is based on historic data and their experience. The study segregates the marine riser asset into functional components and then further segregates the marine riser asset by zones of water depth. Each component is subjected to the selected threats and the likelihood and consequence of failure is assessed. The components and the threats that have a combination of the severe consequence and the greater likelihood are then considered to be the most critical, that is, the risk assessment includes a priority listing of threats and consequences and likelihoods of failure by criticality. The result of the risk assessment is a ranking of the critical components and corresponding threats.

The term “rig” as used herein can refer to a production rig or a drilling rig.

The term “riser engineer” as used herein can refer to an engineer that reviews a marine riser asset tracking model or conducts engineering assessments.

The term “safety factor” as used herein can refer to the prudent and deliberate reduction in the result of a calculation of remaining operating lifetime or time between inspection by applying a discount to the result, thus reducing the remaining operating lifetime or the time between inspection to a fraction of that calculated prior to the application of a safety factor. The aim of the safety factor is to ensure the application of prudent practice by reducing calculated capacity to assure key performance indicators are not exceeded.

The term “schedule of repairs” as used herein can refer to a document or a report that provides details of the flaws identified and the repair, if any, that may be required to each flaw and the required dimensions and condition of the components of the marine riser asset post repair to determine the appropriate remaining operating lifetime or time between inspections.

The term “service history” as used herein can refer to the historical operation, maintenance, physical inspection, and repair record of the marine riser asset.

The term “statistical analysis” as used herein can refer to calculations based on the theory of statistics and probability analysis that can provide confidence about a large population of similar marine riser assets from the statistical analysis of the results of few inspections of assets from the same population of similar assets.

The term “timeline of inspection” as used herein can refer to a document or report that includes a plan of when different types of inspections, such as annual, baseline, and updated baseline are predicted to take place and the anticipated time interval between such inspections. Timeline of inspection can be modified to accommodate ad hoc inspections or can be updated following an assessment conducted annually.

The term “worldwide” as used herein can refer to the any body of water be it a lake, river, sea, ocean or the intersection of any of these, anywhere in the world.

The term “zones of water depth” as used herein can refer to a group of marine riser assets connected together and deployed at a preset segment of water depth. Zones of water depth are identified as an adjustable segment of water depths, such as a zone could be the segment of water depths from 400 feet to 200 feet.

The term “processor” as used herein can be any hardware that carries out computer instructions by performing, for example, arithmetic, logical, and input/output (I/O) operations. A processor may include a central processing unit (CPU), a semiconductor-based microprocessor, a graphics processing unit (GPU), a digital signal processor (DSP), and/or other hardware devices suitable for retrieval and execution of instructions that may be stored in memory.

The term “network” as used herein can be any known network in the industry, such as a satellite network, the internet, a wide area network, a local area network, a cellular network or combinations thereof.

The term “data storage” refers to a non-transitory computer readable medium, such as a hard disk drive, solid state drive, flash drive, tape drive, and the like. The term “non-transitory computer readable medium” excludes any transitory signals but includes any non-transitory data storage circuitry, e.g., buffers, cache, and queues, within transceivers of transitory signals.

The term “sensor” refers to any device that detects physical properties, and/or changes in the environment in which the sensor is located. For example, a sensor can conduct NDT, a sensor can monitor the motion of a riser, a sensor may detect wave heights, etc.

As previously described, marine risers may be subjected to a various dynamic loads, impacts, corrosive fluids and abrasive fluids. Such conditions may result in physical damage, fatigue, corrosion, erosion, or combinations thereof. If the damage to a marine riser is sufficient, it may compromise the integrity of the marine riser and potential result in an inadvertent loss of drilling fluid into the surrounding sea. To reduce and/or minimize these risks, marine risers are traditionally inspected at a preset time interval of 1 or 5 years. In particular, visual inspections of mariner risers are typically performed once a year and non-destructive testing (NDT) inspections are performed once every five years. This conventional approach is applied regardless of the actual threats to the marine risers, the actual condition of the marine riser, the environmental conditions experienced by the marine riser, or the anticipated operating conditions the marine riser asset may experience in subsequent installations.

Embodiments described herein provide a different approach to monitoring and managing the integrity of marine risers, also referred to herein as marine riser assets. In particular, embodiments described herein consider a variety of factors (e.g., threats to the marine riser asset, environmental conditions actually experienced by the marine riser asset and anticipated to be experienced by the marine riser asset, installation location, actual physical condition of the marine riser asset, etc.) and predictive analytics to generate a tailored inspection frequency (e.g., time interval until the marine riser asset should be inspected) and a timeline for any repairs. As a result, there may no longer be a need for an inspection every five years as some marine riser assets may need more frequent inspections (e.g., every two years) due to operating conditions, whereas other marine riser assets may need less frequent inspections (e.g., every seven years), while maintaining a relatively high confidence in mariner riser asset integrity and associated safe operating conditions.

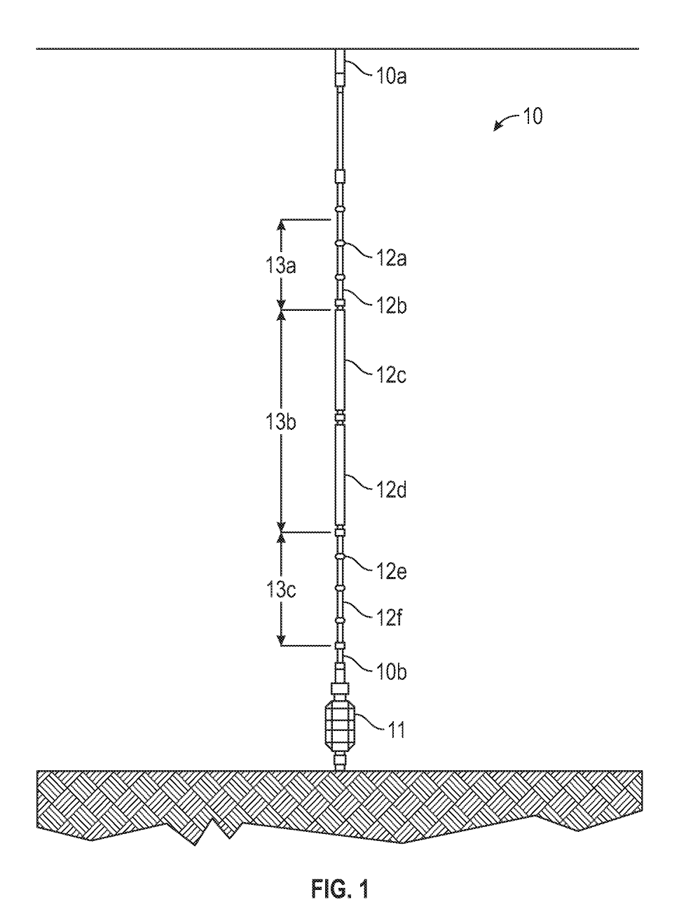

Referring now to FIG. 1, a marine riser 10 is schematically shown. Riser 10 has an upper end 10a coupled to a floating offshore structure (not shown) such as a drilling rig or vessel and a lower end 10b coupled to a Lower Marine Riser Package (LMRP) 11. Thus, riser 10 extends subsea from the floating offshore structure to the LMRP 11. Marine riser 10 is made from a plurality of marine riser segments 12a-12f connected together end-to-end. In FIG. 1, marine riser segments 12a-12f are shown in zones of water depths 13a-13c. In particular, segments 12a, 12b are disposed in the zone of water depth 13a, segments 12c. 12d are disposed in the zone of water depth 13b, and segments 12e, 12f are disposed in the zone of water depth 13c.

As will be described in more detail below, embodiments described herein are directed to systems and methods for monitoring each of the individual marine riser segments (e.g., segments 12a-12f), determining the frequency of inspection of each of the mariner riser segments, and identifying and scheduling remedial actions for the each marine riser segment to ensure integrity of each marine riser segment. Accordingly, as used herein, the term “marine riser asset” refers to an individual joint or segment of a subsea marine riser. Although marine riser 10 is a drilling riser, in general, a “marine riser asset” refers to any marine riser joint or segment known in the art such as a marine drilling riser joint, a marine production riser joint, etc.

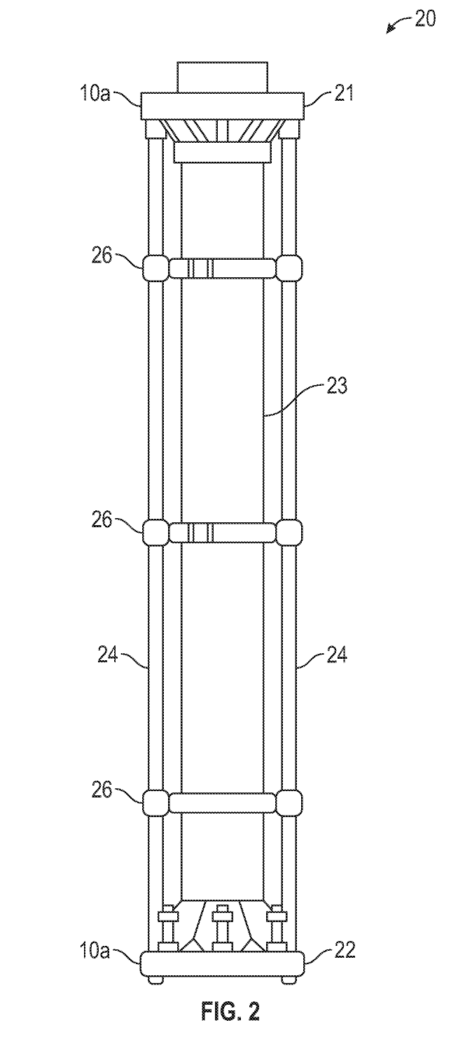

Referring now to FIG. 2, one exemplary marine riser asset 20 is shown. In general, marine riser asset 20 can be used for any one or more of the segments 12a-12f shown in FIG. 1. Marine riser asset 20 has a first or upper end 20a and a second or lower end 20b. In addition, asset 20 includes a connection flange 21 at upper end 20a, a connection flange 22 at lower end 20b, a tubular pipe or conduit 23 extending between flanges 21, 22, and auxiliary lines 24, 25 coupled to conduit 23. Flanges 21, 22 are attached to conduit 23 via welding, and auxiliary lines 24, 25 are coupled to conduit 23 via a plurality of connectors 26. Flanges 21, 22, conduit 23, auxiliary lines 24, 25, connectors 26, and the welds securing flanges 21, 22 to conduit 23 are “components” of marine riser asset 20. Thus, as used herein, the term “components” refers to sections, individual parts, and assemblies that are connected together to form a marine riser asset. Components can include a joint, a weld, a fitting, or a relief valve.

Referring again to FIG. 1, the floating offshore structure may move relative to the LMRP 11 and subsea currents may act on riser 10, thereby applying tensile loads, torsional loads, and lateral loads to riser 10 as previously described. In addition, during drilling operations, drilling fluid is pumped from the floating structure down a drillstring that extends through the riser 10 and LMRP 11, and then back up the annulus between the drillstring and the riser 10. Thus, the inner surface of the riser 10 is exposed to the drilling fluid and associated fluid pressure, while the outer surface of the riser 10 is exposed to the surrounding sea water. As previously described, such conditions may physically damage riser 10, fatigue riser 10, corrode riser 10, erode riser 10, or combinations thereof.

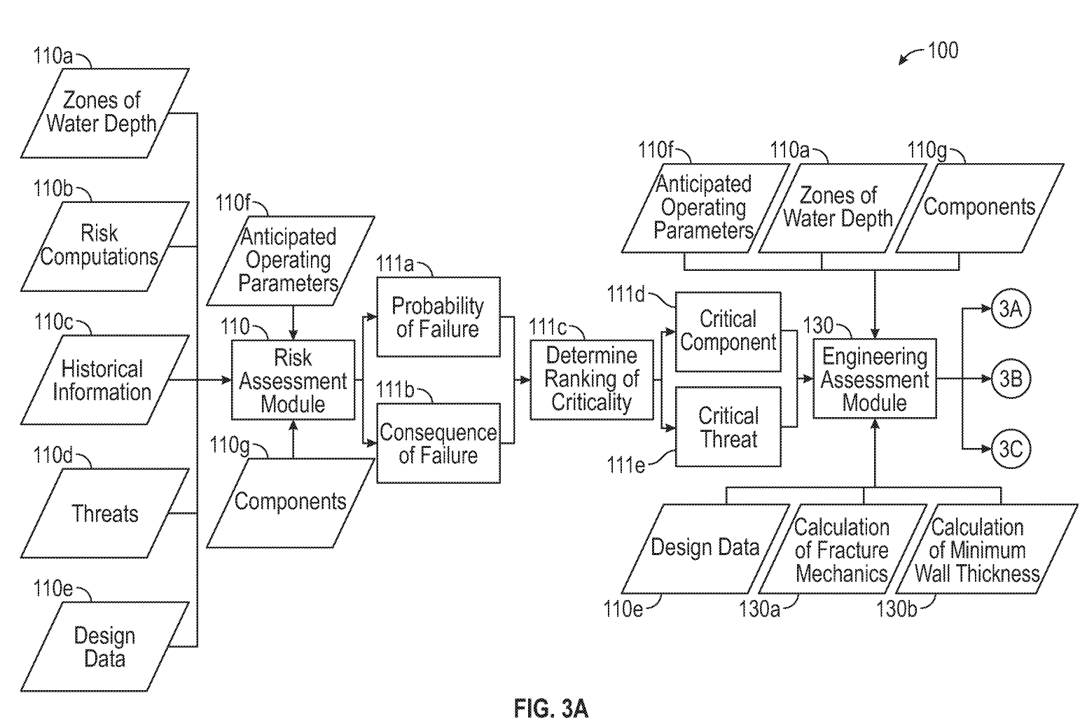

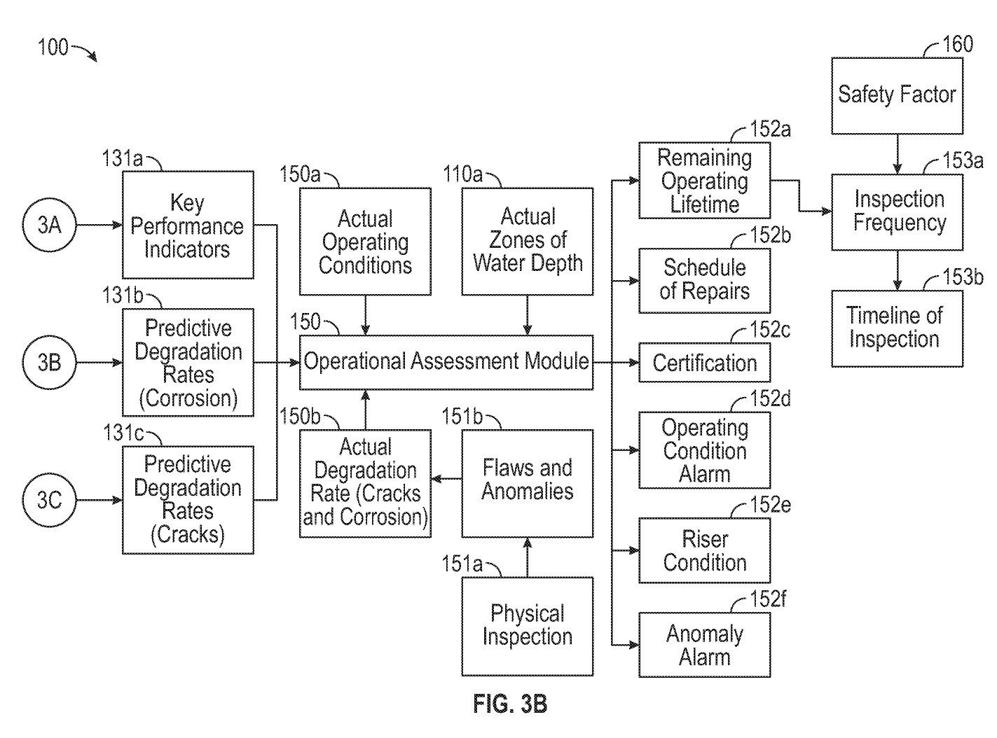

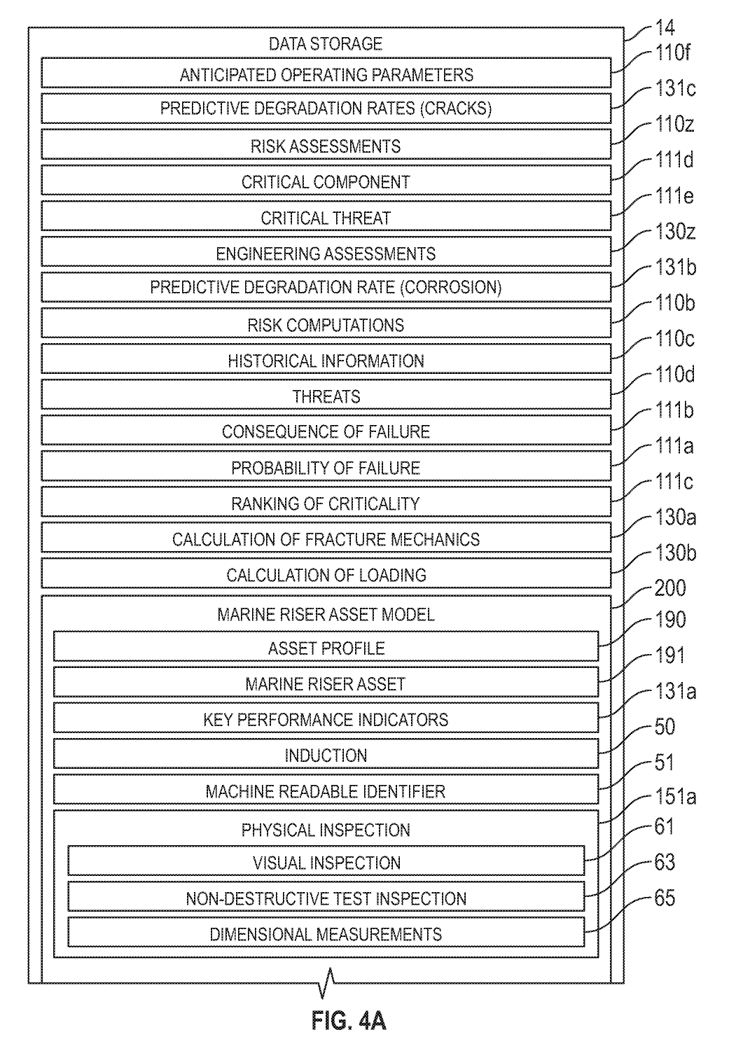

Referring now to FIGS. 3A and 3B, an embodiment of a system 100 for monitoring a plurality of marine riser assets, and condition thereof, and managing the remaining operating lifetime of the plurality of marine riser assets is shown. In this embodiment, system 100 includes a risk assessment module 110, an engineering assessment module 130, and an operational assessment module 150. Each module 110, 130, 150 receives a plurality of inputs and provides a plurality of outputs, which are communicated to the other modules 110, 130, 150. In particular, the outputs of module 110 are communicated to module 130, and the outputs of module 150 are communicated to module 150. As will be described in more detail below, the risk assessment module 110 determines the component(s) of each marine riser asset with the greatest likelihood of failure, referred to as the “critical component(s),” and the likely failure mode of the critical component(s) with particular emphasis on corrosion and cracks; the engineering assessment module 130 determines the predicted degradation rates of the critical component(s) with respect to corrosion and cracks; and the operational assessment module 150 determines the frequency of inspection for the critical component(s). The frequency of inspection determination is then used to schedule future physical inspections and repairs, which are performed in due course. Although risk assessment module 110, engineering assessment module 130, and operational assessment module 150 are described as modules, which may be implemented by electronic circuits, in some embodiments, one or more of the modules may include or consider empirical analyses. In the embodiment of system 100 shown in FIGS. 3A and 3B, the operational assessment module 150 is an electronic circuit, such as a processor.

Referring first to FIG. 3A, for each marine riser asset, the risk assessment module 110 receives the zone of water depth 110a, a plurality of risk computations 110b, historical information 110c, a list of threats 110d, design data 110e, a list of anticipated operating parameters 110f, and a list of components 110g. The zones of water depth 110a provides the depth at which each marine riser asset will be deployed. Threats 110d include a list of the potential physical risks to the marine riser assets including erosion, corrosion, fatigue, and mechanical failure (e.g., cracks). Design data 110e includes the physical properties of the marine riser assets and components thereof including, without limitation, weld strengths and material thicknesses (e.g., flange thickness, conduit wall thickness, etc.). Anticipated operating parameters 110f includes the conditions that each marine riser asset is expected to experience upon deployment including, without limitation, internal and external pressures, drilling mud composition, sea water composition, subsea currents and related loads, bending loads, and tensile loads. The list of components 110g identifies the individual components of each marine riser asset including, without limitation, the end flanges, welds, and the pipe conduit. The risk computations 110b provide the likelihood and consequence of each threat 110d to each component 110g, as a function of the zone of water depth 110a. Historical information 110c includes information relating to historical incidents of failure of particular components of marine riser assets.

The risk assessment module 110 or the plurality of risk computations 110b generate results, which indicate the likelihood of failure 111b of each component and a consequence of each failure 111c (e.g., where will the failure occur, will the failure result in pollution, etc.). A variety of API standards, such as API-RP-580, known in the art can be used within the risk assessment module 110 to assess the probability of failure 111b and the consequence of failure 111c. The probability of failure 111a and the consequence of failure 111b can then provide a ranking of criticality 111c, which identifies a critical component 111d and a critical threat 111e for each marine riser asset. In general, the critical component 111d and the critical threat 111e represent the component of the marine riser asset that is most likely to fail (e.g., weld between flange and conduit) and the failure mode of that component (e.g., corrosion, crack, etc.), respectively. The critical component 111d and the critical threat 111e of each marine riser asset are evaluated in the engineering assessment module 130.

Referring still to FIG. 3A, the engineering assessment module 130 receives the zone of water depth 110a, design data 110e, anticipated operating parameters 110f, list of components 110g, the critical component 111d and the critical threat 111e for each marine riser asset. A calculation of fracture mechanics 130a and a calculation of minimum wall thinkness 130b are also provided to the engineering assessment module 130. The calculation of fracture mechanics 130a provides an estimation of crack propagation and a rate of crack growth until the crack reaches a size of potential. The calculation of minimum wall thickness 130b indicates the allowable material thickness loss for continued safe operation of a component. The outputs from the calculation of fracture mechanics 130a and outputs from the calculation of minimum wall thickness 130b may be used as inputs by the engineering assessment module 130 to outputs.

The engineering assessment module 130 generates outputs of key performance indicators 131a, the predictive degradation rates for corrosion 131b, and predictive degradation rates for cracks 131c for each marine riser asset. The key performance indicators 131a identify the operating parameters 110f that have the greatest impact on crack propagation and corrosion for the critical components 111d and critical threats 111e. The predictive degradation rates for corrosion 131b are determined for the critical components 111d in which the critical threat is corrosion, and the predictive degradation rates for cracks 131c are determined for the critical components 111d in which the critical threat is crack propagation. The predictive degradation rates for corrosion 131b can be calculated using the Von Mises equation, API 16Q standard, and API BULL 5C3 standard based on internal pressure, external pressure, and tensile loads. The predictive degradation rates for cracks 131c can be calculated using BS 7910 and API 579 standards. For the initial engineering assessment prior to deployment of the marine riser assets, the engineering assessment module 130 presupposes a crack of the largest undetected size (e.g., 3/16^{th} of an inch) exists in certain critical components 111d in which the critical threat 111e is crack propagation.

The operational assessment module 150, which as discussed above, is, in an embodiment, implemented in a processor, receives the key performance indicators 131a, the predictive degradation rates for corrosion 131b, and the predictive degradation rates for cracks 131c. Additionally, the operational assessment module 150 receives the actual zones of water depth 110a, the actual operating conditions 150a, and the actual degradation rate for both cracks and corrosion 150b. The actual degradation rate 150b, in an embodiment, is determined based on a physical inspection 151a of the components of the marine riser asset.

The physical inspection 151a may be conducted by sensors, by trained engineers or other persons, and/or any other inspection method (e.g., NDT). For example, one or more sensors, not shown, may be configured to detect flaws and anomalies 151b in the marine riser asset. The flaws and anomalies 151b may include cracks (e.g., identify the locations and geometries, e.g., crack widths and lengths, in specific components of the marine riser asset), corrosion (e.g., the size of an area and depth of corrosion in the components of the marine riser asset), and/or other flaws or anomalies detected in the components of the marine riser asset. Thus, a sensor may detect, in an example, the length of a crack in a component of the marine riser asset. The actual degradation rate 150b for each of the detected flaws and anomalies 151b is determined. For example, a processor may determine that a crack has grown in length by 1 cm over the past year (since the previous physical inspection). In this example, the actual degradation rate 150b for the specific crack is 1 cm per year.

The actual operating conditions 150a can be determined based on data received from sensors in the operating environment of the marine riser asset. For example, a sensor may be deployed at various locations along the actual zones of water depth 110a to determine wave heights, currents, riser movement, etc.

The operational assessment module 150 is configured, in an embodiment, to determine and/or generate the remaining operating lifetime 152a, a schedule of repairs 152b, a certification 152c, an operating condition alarm 152d, a condition 152e, and/or an anomaly alarm 152f based on the inputs received. In one example, the operational assessment module 150 may take the higher (larger) degradation rate between the received predictive degradation rates 131b-c and the actual degradation rate 150b. For example, if the actual degradation rate 150b for a crack is 1 cm per year and the predictive degradation rate 131c is 2 cm per year, the operational assessment module 150 will utilize the predictive degradation rate 131c of 2 cm per year to make a determination of the remaining operating lifetime 152a. The remaining operating lifetime 152a may be determined based on a baseline of parameters. For example, one component of a marine riser asset may be able to operate until a crack is 40 cm long. Continuing the previous example, because the degradation rate 131c is 2 cm per year, the remaining operating lifetime is 20 years for the crack. However, if another parameter (e.g., corrosion) leads to a lower remaining operating lifetime (e.g., 10 years), then the operational assessment module 150 will determine the remaining operating lifetime 152a at the lowest of the remaining operating lifetimes calculated. Thus, in this example, the operational assessment module 150 will determine that the remaining operating lifetime 152a for the marine riser asset is 10 years.

The operational assessment module 150 also, in an embodiment, determines an inspection frequency 153a based on the remaining operating lifetime 152a, and in some embodiments, a safety factor 160. The safety factor 160 may be any percentage of the remaining operating lifetime 152a. In some embodiments, the safety factor 160 is 30 percent of the remaining operating lifetime 152a. In other embodiments, the safety factor 160 is any percentage between 10 percent and 90 percent of the remaining operating lifetime 152a. The operational assessment module 150 determines, in an embodiment, the inspection frequency 152a by multiplying the remaining operating lifetime 152a with the safety factor 160. For example, if the remaining operating lifetime 152a for the riser is 10 years and the safety factor 160 is 20 percent, the inspection frequency 153a is 2 years. The operational assessment module 150 then may generate a timeline of inspection 153b that mirrors the inspection frequency 153a. In other words, a timeline of inspection 153b may be determined based on the inspection frequency 153a. For example, if the inspection frequency 153a is 2 years, then the timeline of inspection 153b will be set 2 years from the date of the current inspection.

In addition to determining the remaining operating lifetime 152a, the inspection frequency 153a, and the timeline of inspection 153b, the operating assessment module 150 may schedule repairs 152b by comparing the key performance indicators 131a to the results of the physical inspection 151a. Similarly, the operational assessment module 150 may provide certification 152c for use of the marine riser asset based on the physical inspection. If the one or more of the actual operating conditions 150a is above a threshold level, the operational assessment module 150 may generate an operating condition alarm 152d. In another example, the key performance indicators 131a can be compared to the physical inspection 151 and/or to a condition 152e, and the operational assessment module 150 may actuate the operating condition alarm 152d when the condition of the marine riser asset falls below or exceeds the key performance indicators 131a.

Once the timeline of inspection 153b indicates that the next inspection is due, another inspection may be completed. Utilizing the data from the previous inspection as and comparing this to the latest inspection allows the determination of a new degradation rate. The operational assessment module 150 then may determine a new remaining operating lifetime 152a and inspection frequency 153a, as well as a new schedule of repairs 152b, certification 152c, operating condition alarm 152d, condition 152e, and anomaly alarm 152f based on the previous inspection degradation rates and the new inspection degradation rates. In this way, inspections may be scheduled at optimum and/or near optimum frequency based on the actual condition of the components of the marine riser asset rather than a calendar based schedule. Similarly, the operational assessment module 150 may actuate an anomaly alarm 152f when at least one of the flaws and anomalies 151b falls below or exceeds the key performance indicators 131a for the marine riser asset at the zone of water depth 110a.

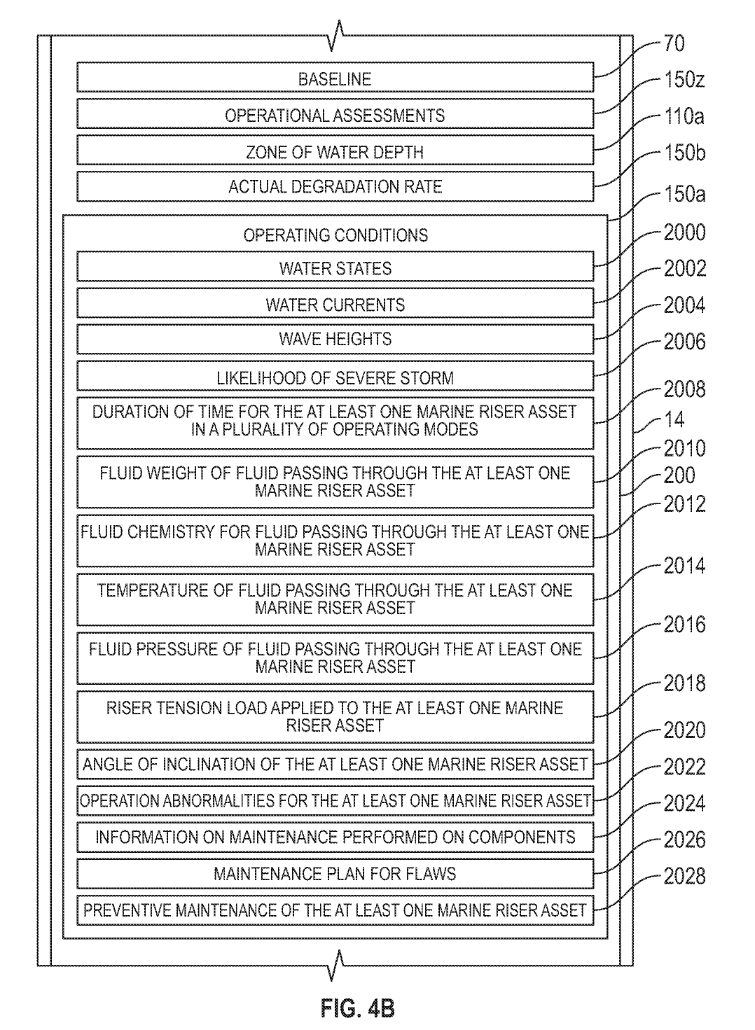

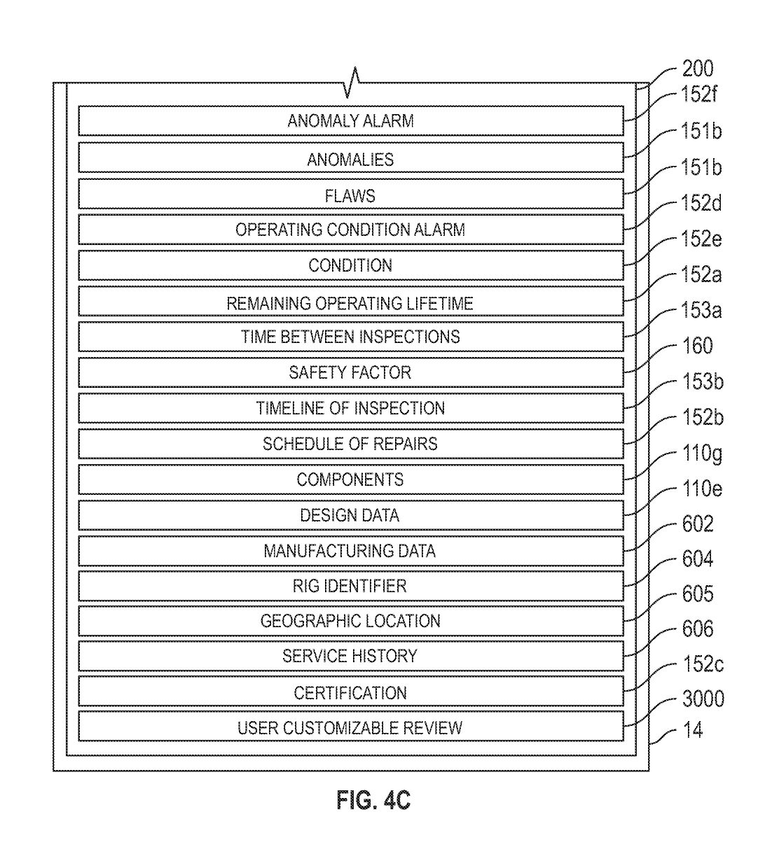

FIGS. 4a-4c depict a data storage 14 usable with the system 100 according to one or more embodiments. The data storage 14 may be in the form of flash, read-only memory, random access memory, or any other type of memory or combination of types of memory including memory located offsite from the rig in which marine riser asset is located.

The data storage 14 can contain (e.g., store) the anticipated operating parameters 110f and predictive degradation rates for cracks 131c of. The data storage 14 can also contain (e.g., store) the risk assessments 110z generated by the risk assessment module 110 and the engineering assessments 130z generated by the engineering assessment module 130. Thus, when risk assessments and engineering assessments are performed, they can then be stored in the data storage 14. The data storage 14 can also contain (e.g., store) the predictive degradation rate for corrosion 131b, the risk computations 110b, and the historical information 110c. The data storage 14 can also contain (e.g., store) the threats 110d, the consequence of failure 111b, the probability of failure 111a, the ranking of criticality 111c, the calculation of fracture mechanics 130a and the calculation of minimum wall thickness 130b. The data storage 14 can also contain (e.g., store) a marine riser asset tracking model 200, which can contain an assett profile 190 that profiles the particulars of the asset including the owner of the rig in which the marine riser asset is installed, at least one marine riser asset 191, such as the name and information associated therewith, and key performance indicators 131a.

In embodiments, the marine riser asset tracking model 200 can also contain an induction 50 (e.g., design data, manufacturing data, dimension data, rig identifiers, geographic locations of the rig, service history, certifications, etc.) and a machine readable identifier 51. The marine riser tracking model 200 can contain the physical inspection 151a. The physical inspection 151a can include a visual inspection 61, a non-destructive test inspection 63, and dimensional measurements 65. The marine riser tracking model 200 can also contain the baseline 70, operational assessments 150z generated by the operational assessment module 150, the zone of water depth 110a and the actual degradation rate 150b. The data storage 14 can also contain (e.g., store) operating conditions 150a around the at least one marine riser asset.

The operating conditions 150a can include water states 2000, water currents 2002, wave heights 2004, likelihood of a severe storm 2006, duration of time for the at least one riser asset in a plurality of operating modes 2008, fluid weight of fluid passing through the at least one marine riser asset 2010, fluid chemistry for fluid passing through the at least one marine riser asset 2012, temperature of fluid passing through the at least one marine riser asset 2014, and fluid pressure of fluid passing through the at least one marine riser asset 2016. The operating conditions 150a can also include riser tension load applied to the at least one marine riser asset 2018 and an angle of inclination of the at least one marine riser asset 2020. The operating conditions 150a can also include operating abnormalities for the at least one marine riser asset 2022. The operating conditions 150a can also include information on maintenance performed on components 2024, a maintenance plan for flaws 2026 and a preventive maintenance for the at least one marine riser asset 2028.

The marine riser asset tracking model 200 can also have an anomaly alarm 152f which can be actuated when at least one of the plurality of anomalies 151b falls below or exceeds the key performance indicators 131a for the marine riser asset at the zone of water depth. The marine riser asset tracking model 200 can also have anomalies and flaws 151b for the marine riser asset. The marine riser asset tracking model 200 can also have an operating condition alarm 152d, which can be actuated when the operating conditions 150a fall below or exceed anticipated operating parameter (e.g., fall below a threshold value).

The key performance indicators 131a can be compared to the physical inspection 60 and to a condition 152e, which can be in the marine riser asset tracking model 200, of the at least one marine riser and actuate the operating condition alarm 152d when the condition of the marine riser asset falls below or exceeds the key performance indicators 131a.

The marine riser asset tracking model 200 can also contain the calculated remaining operating lifetime 152a of the at least one marine the riser asset as computed using the operating assessment module 150, the actual degradation rate 150b, the predictive degradation rates 131b-c, the operating conditions 150a, the flaws and anomalies 151b, and the physical inspection 151a. The marine riser asset tracking model 200 can also contain the calculated amount of time between inspections 153a based on the determined remaining operating lifetime 152a. The marine riser asset tracking model 200 can also contain the safety factor 160 that is used to calculate the amount of time between inspections 153a by multiplying the remaining operating lifetime 152a by the safety factor 160, which in some embodiments, is between 10 percent to 90 percent of the remaining operating lifetime 152a. The marine riser asset tracking model 200 can also have the timeline of inspection 153b for the at least one marine riser asset, which can be determined using the remaining operating lifetime 152a multiplied by the safety factor 160. The marine riser asset tracking model 200 can have the schedule of repairs 152b for the at least one marine riser asset, which can be determined by comparing the results of the physical inspection 151a to the key performance indicators 131a. In embodiments, the marine riser asset tracking model 200 can include components 110g, design data 110e, manufacturing data 602, rig identifier 604, geographic location 605, service history 606, certification 152c, and a user customizable review 3000.

In embodiments, the marine riser asset tracking model 200 may present the user customizable review 3000 of risk assessments and engineering assessments against real time operating conditions and the conditions of the at least one marine riser asset to provide a variable unit of time between inspections presenting inspections as needed based on the condition and the operating conditions for the at least one marine riser asset to the client device to minimize down time for the at least one marine riser asset.

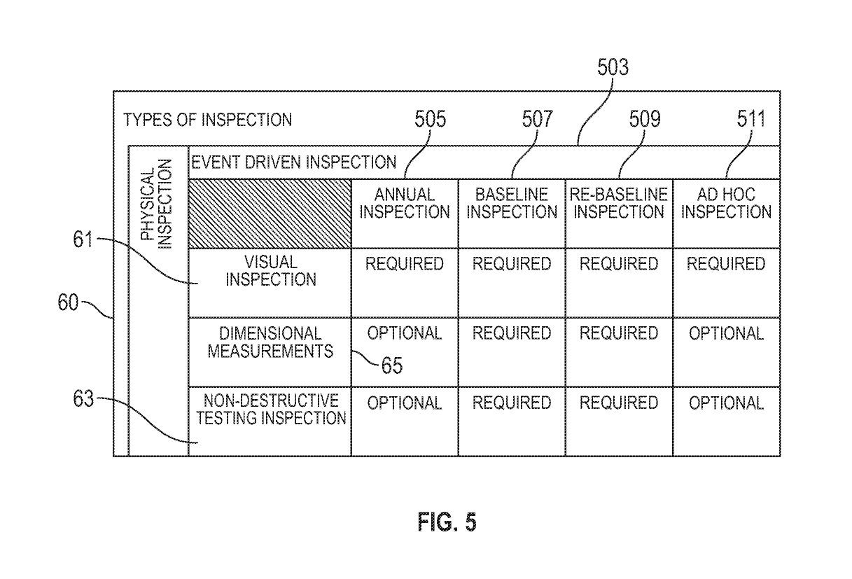

FIG. 5 depicts types of inspections of a marine riser asset according to one or more embodiments. The system can utilize various types of inspection, such as a physical inspection 151a and event driven inspections 503. The physical inspections 151A can include a visual inspection 61, a non-destructive testing inspection 63, and dimensional measurements 65. The event driven inspections 503 can include an annual inspection 505, a baseline inspection 507, a re-baseline inspection 509, and an ad hoc inspection 511. The various types of inspections are shown as being required or optional; however, in alternative embodiments, the various types of inspections may not be required and/or optional.

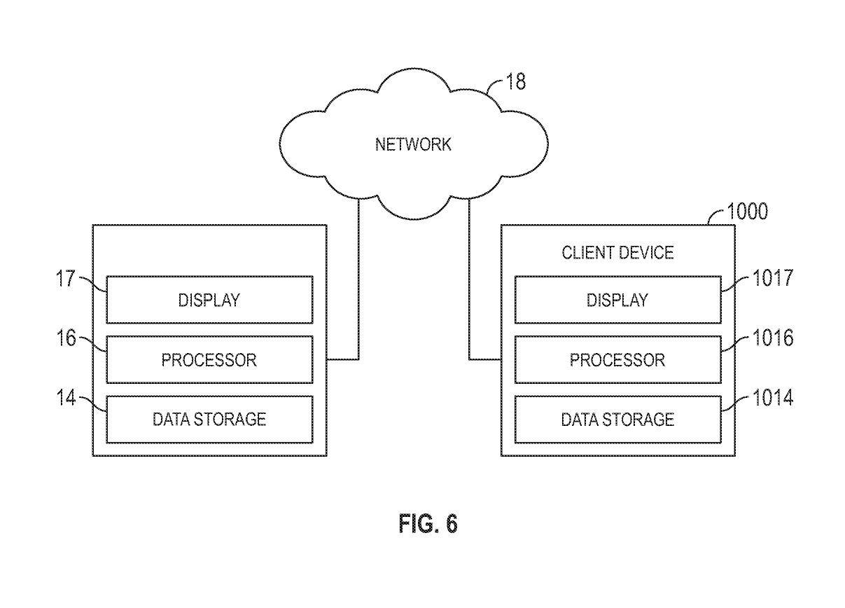

FIG. 6 depicts a system with a network in communication with a processor and a data storage according to one or more embodiments. A processor 16 can be in communication with or can contain a data storage 14. The data storage 14 is non-transitory computer readable media, which can contain computer instructions to instruct the processor 16 to perform various tasks. In embodiments the processor 16 can be any hardware that carries out computer instructions by performing, for example, arithmetic, logical, and input/output (I/O) operations. The processor 16 may be a central processing unit (CPU), a semiconductor-based microprocessor, a graphics processing unit (GPU), a digital signal processor (DSP), and/or other hardware devices suitable for retrieval and execution of instructions that may be stored in memory. The processor 16 may be included in a computer, groups of computers or cloud based processors, which can be connected to or in communication with a network 18.

The network 18 can be a satellite network, a cellular network, a local area network, a global communication network, a wide area network, a fiber optic network, or combinations thereof. The processor 16 can be connected to and in communication with a display 17. A client device 1000 can be connected or in communication with the network 18, wherein the client device 1000 can be a cellular phone, a smart phone, a tablet computer, a laptop, a computer or any device known in the art capable of processing data and having bi-directional capabilities. The client device 1000 can have a client device display 1017, which can be connected to a client device processor 1016 and a client device data storage 1014.

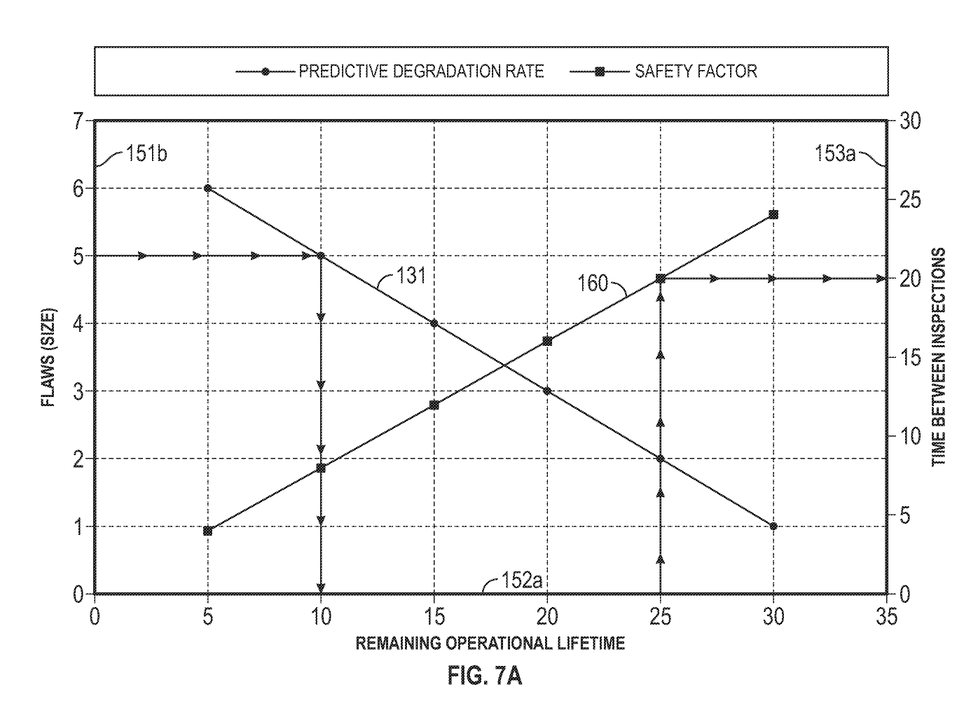

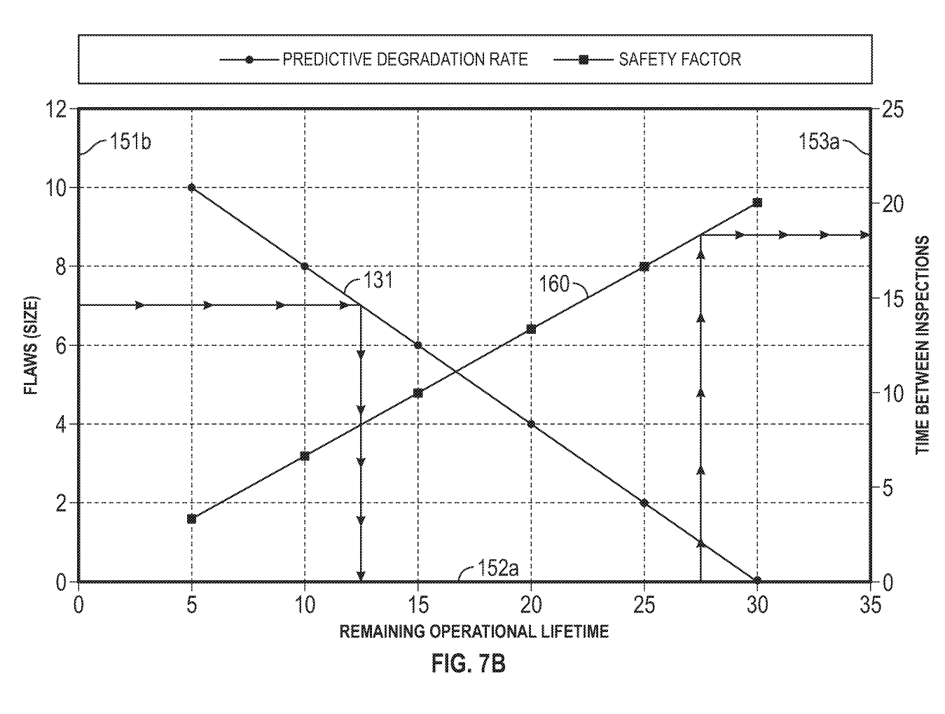

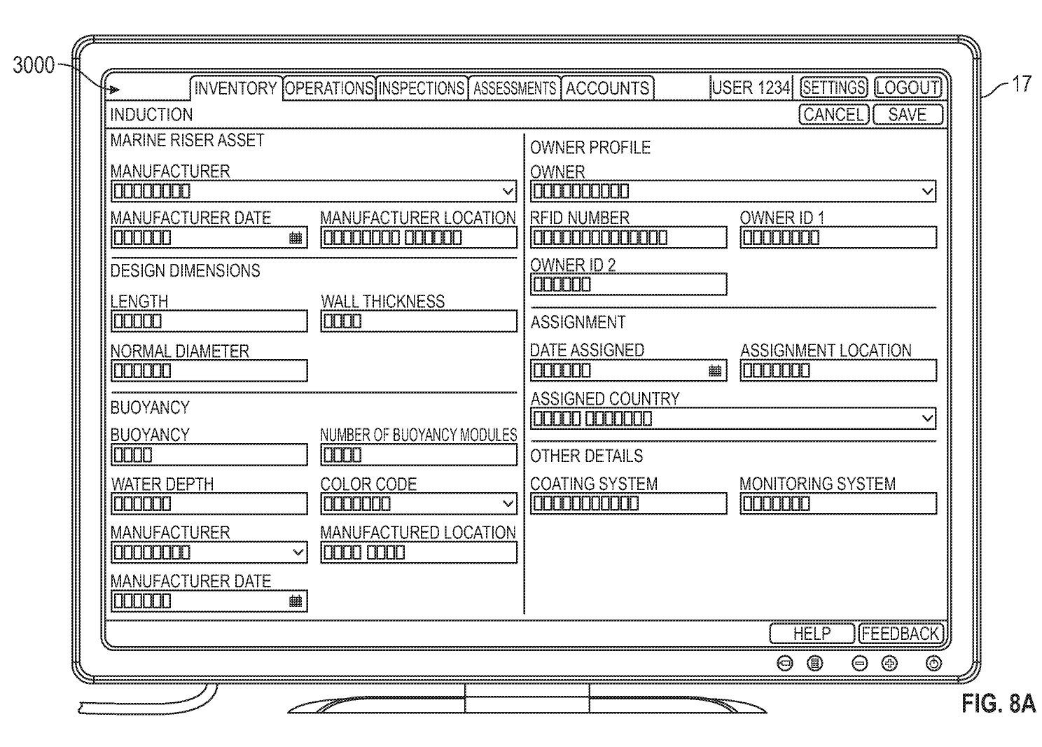

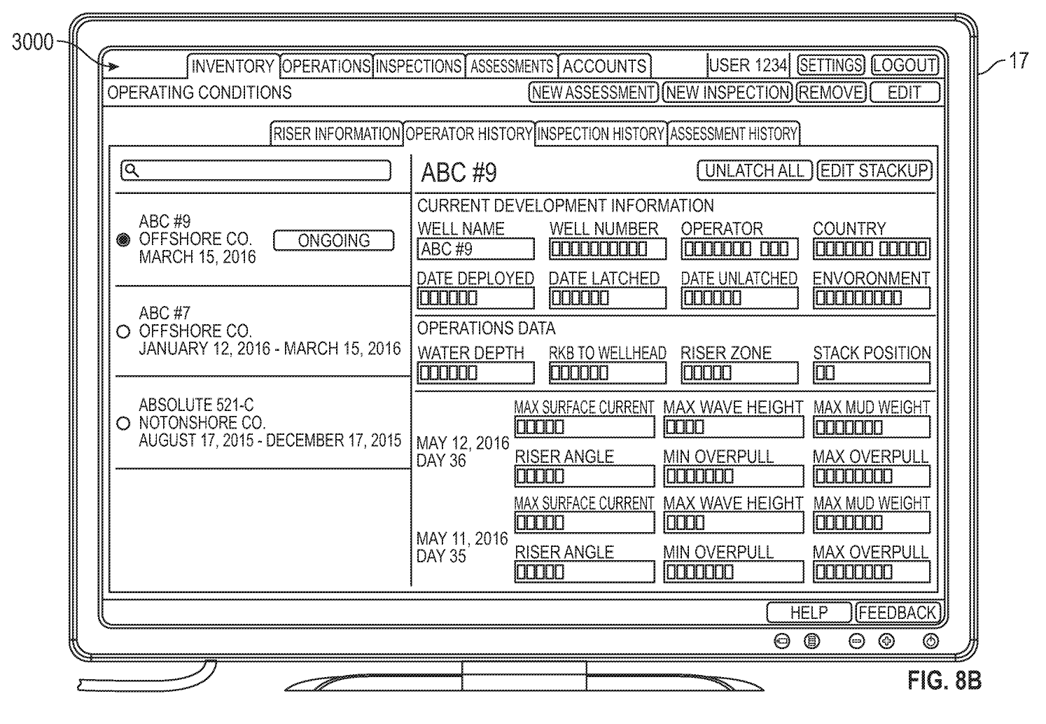

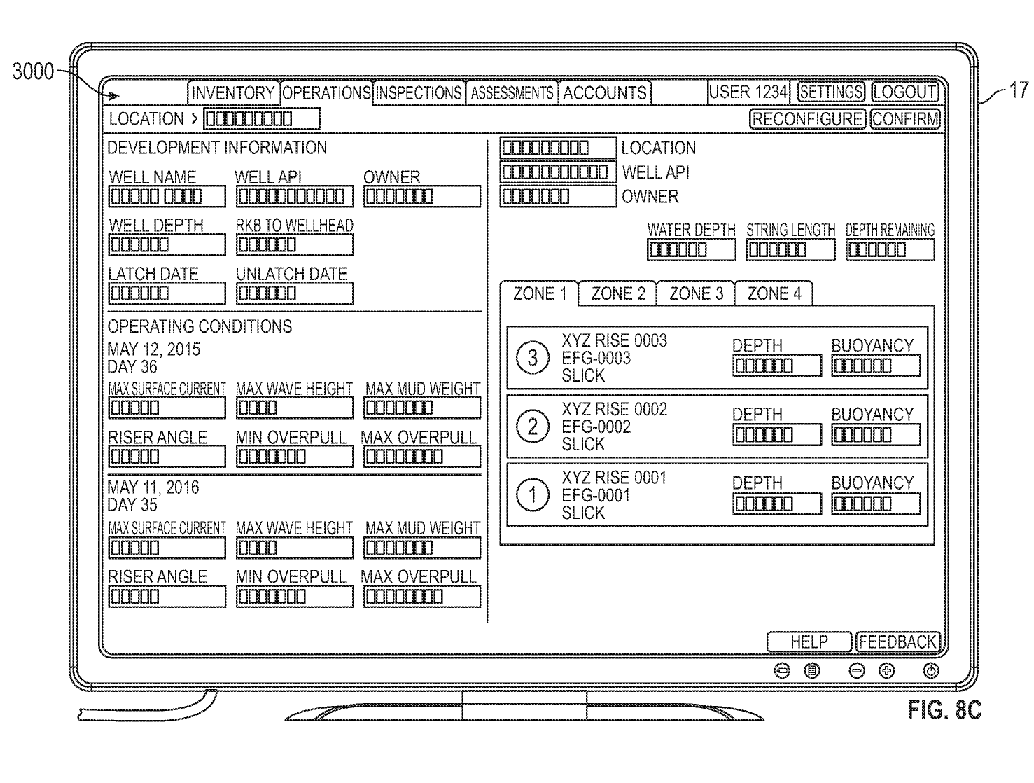

FIGS. 7A and 7B depict remaining operating lifetimes for two different marine riser assets according to one or more embodiments. The predictive degradation rate 131 and the safety factor 160 are shown plotted on the graphs, which show that as the predictive degradation rate 131 decreases, the safety factor 160 and the flaws 151b increase. The safety factor 160 is used to calculate the amount of time between inspections 153a by multiplying the remaining operating lifetime 152a by the safety factor 160, wherein the safety factor 160 may be variable from 10 percent to 90 percent of the remaining operating lifetime 152a.

FIGS. 8A-8E depict the user customizable review according to one or more embodiments. The user customizable review 3000 can be displayed on the display 17, the client device display 1017, or both the display and the client device display. The user customizable review 3000 can display or present on the displays risk assessments and engineering assessments against real time operating conditions and the conditions of the at least one marine riser asset to provide a variable unit of time between inspections presenting inspections as needed based on the condition and the operating conditions for the at least one marine riser asset to the client device to minimize down time for the at least one marine riser asset. The user customizable review 300 can display the induction, the operating conditions, the location, new operation, and the physical inspection.

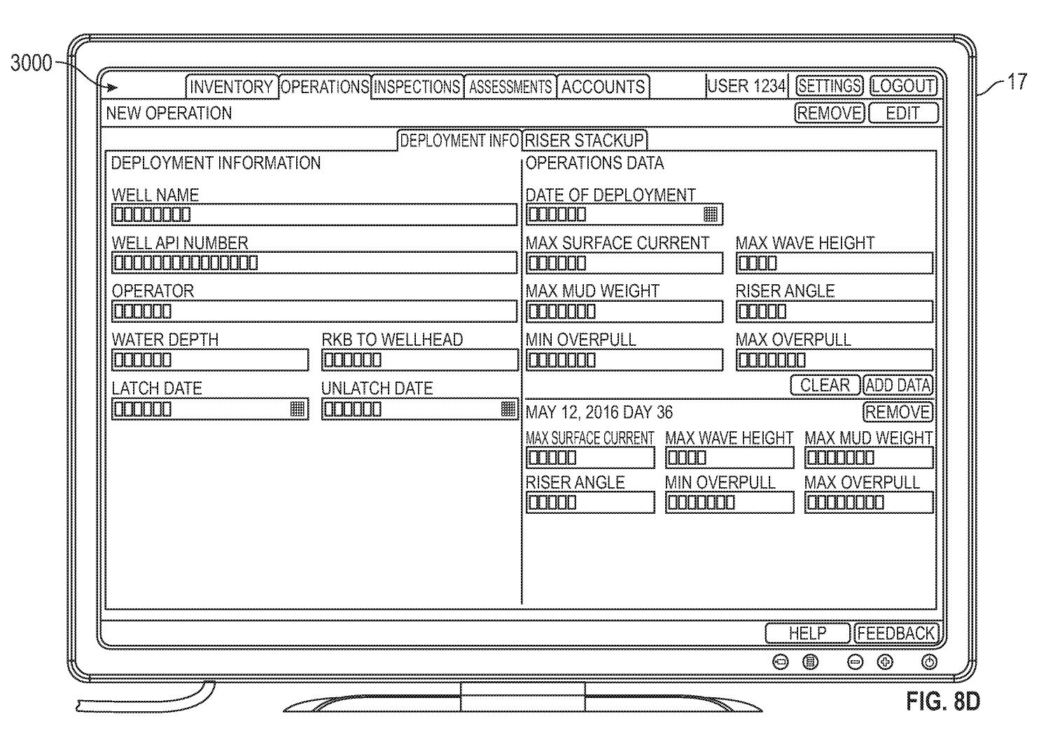

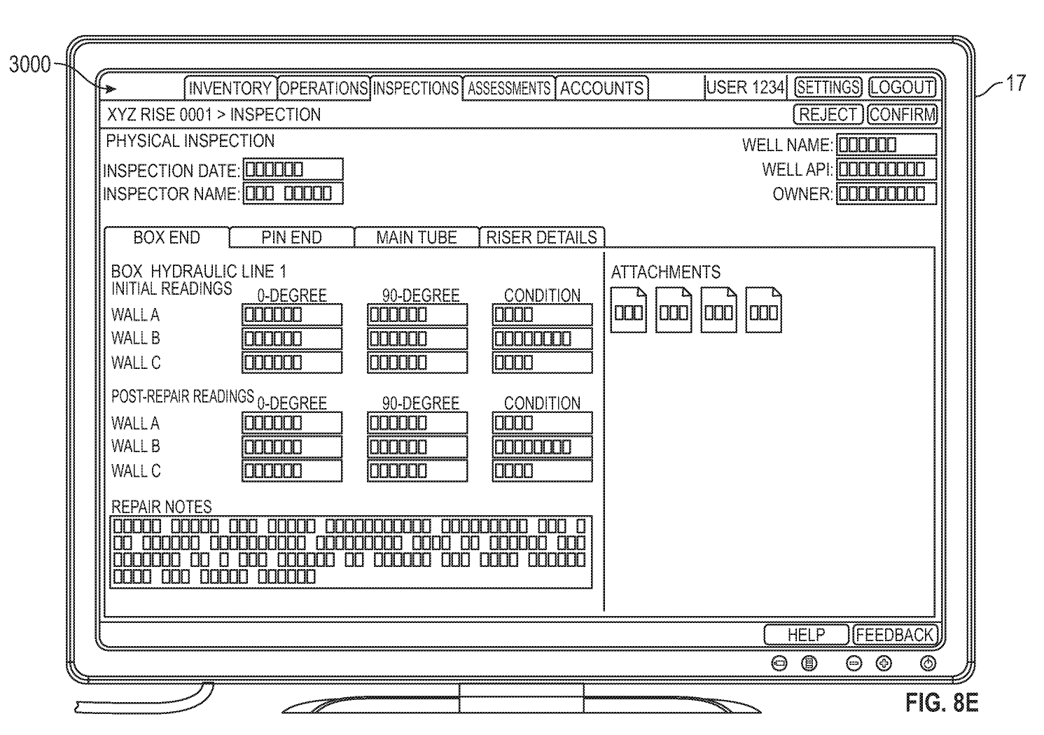

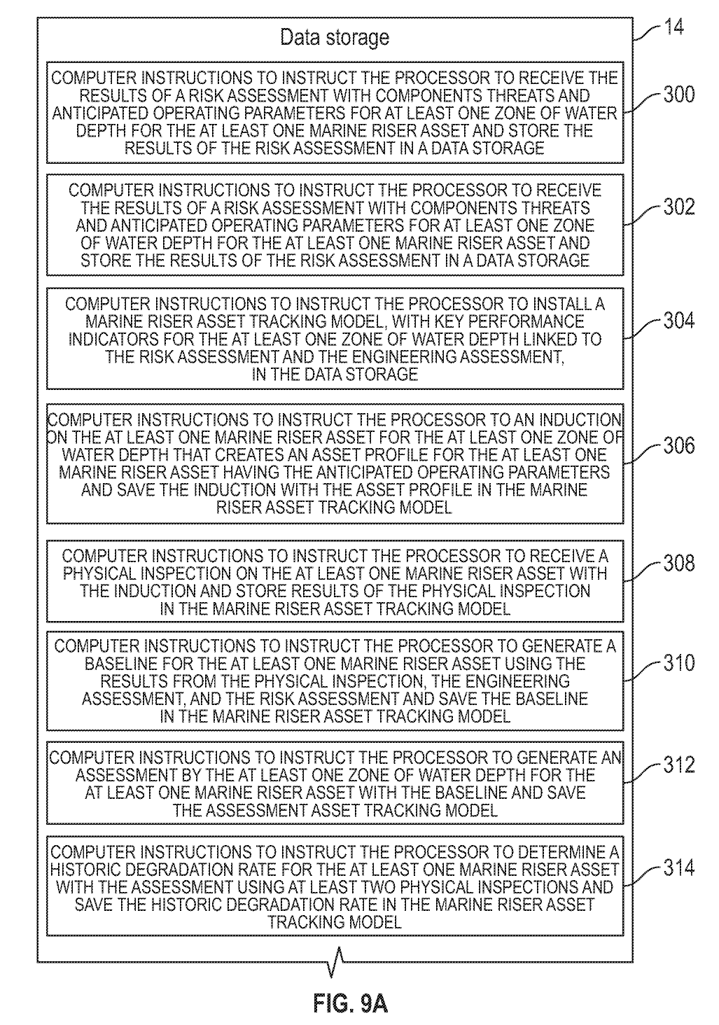

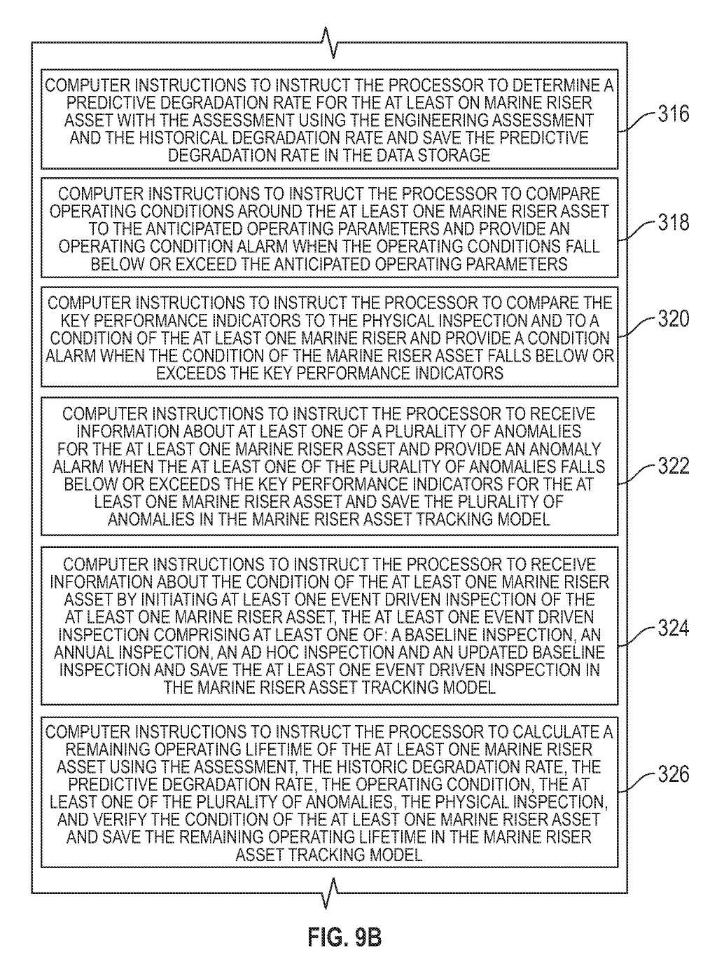

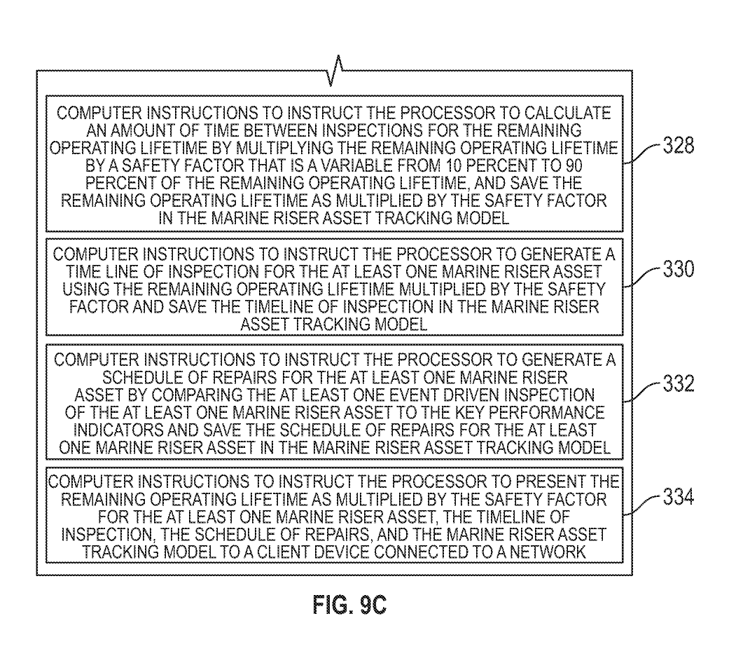

FIGS. 9A and 9B show an exemplary data storage with computer instructions according to one or more embodiments. The data storage 14 can contain computer instructions 300 to instruct the processor to receive the results of a risk assessment with components, threats and anticipated operating parameters for at least one zone of water depth for the at least one marine riser asset and store the results of the risk assessment in a data storage.

The data storage 14 can contain computer instructions 302 to instruct the processor to receive the results of an engineering assessment having anticipated operating parameters for the at least one marine riser asset in at least one zone of water depth and store the results of the engineering assessment in the data storage.

The data storage 14 can contain computer instructions 304 to instruct the processor to install a marine riser asset tracking model with key performance indicators for the at least one zone of water depth linked to the risk assessment and the engineering assessment in the data storage.

The data storage 14 can contain computer instructions 306 to instruct the processor to receive an induction on the at least one marine riser asset for the at least one zone of water depth that creates an asset profile for the at least one marine riser asset having anticipated operating parameters and save the induction with the asset profile in the marine riser asset tracking model.

The data storage 14 can contain computer instructions 308 to instruct the processor to receive a physical inspection on the at least one marine riser asset with the induction and store results of the physical inspection in the marine riser asset tracking model.

The data storage 14 can contain computer instructions 310 to instruct the processor to generate a baseline for the at least one marine riser asset using the results from the physical inspection, the engineering assessment, and the risk assessment and save the baseline in the marine riser asset tracking model.

The data storage 14 can contain computer instructions 312 to instruct the processor to generate an assessment by the at least one zone of water depth for the at least one marine riser asset with the baseline and save the assessment in the marine riser asset tracking model.

The data storage 14 can contain computer instructions 314 to instruct the processor to determine a historic degradation rate for the at least one marine riser asset with the assessment using at least two physical inspections and save the actual degradation rate in the marine riser asset tracking model.

The data storage 14 can contain computer instructions 316 to instruct the processor to determine a predictive degradation rate for the at least one marine riser asset with the assessment using the engineering assessment and the actual degradation rate and save the predictive degradation rate in the data storage.

The data storage 14 can contain computer instructions 318 to instruct the processor to compare operating conditions around the at least one marine riser asset to the anticipated operating parameters and provide an operating condition alarm when the operating conditions fall below or exceed the anticipated operating parameters.

The data storage 14 can contain computer instructions 320 to instruct the processor to compare the key performance indicators to the physical inspection and to a condition of the at least one marine riser and provide a condition alarm when the condition of the marine riser asset falls below or exceeds the key performance indicators.

The data storage 14 can contain computer instructions 322 to instruct the processor to identify and monitor at least one of a plurality of anomalies for the at least one marine riser asset and provide an anomaly alarm when the at least one of the plurality of anomalies falls below or exceeds the key performance indicators for the at least one marine riser asset and save the plurality of anomalies in the marine riser asset tracking model.

The data storage 14 can contain computer instructions 324 to instruct the processor to verify the condition of the at least one marine riser asset by initiating at least one event driven inspection of the at least one marine riser asset, the at least one event driven inspection comprising at least one of: a baseline inspection, an annual inspection, an ad hoc inspection and an updated baseline inspection and saving the at least one event driven inspection in the marine riser asset tracking model.

The data storage 14 can contain computer instructions 326 to instruct the processor to calculate a remaining operating lifetime of the at least one marine riser asset using the assessment, the historic degradation rate, the predictive degradation rate, the operating condition, the at least one of the plurality of anomalies, the physical inspection, and verify the condition of the at least one marine riser asset and save the remaining operating lifetime in the marine riser asset tracking model.

The data storage 14 can contain computer instructions 328 to instruct the processor to calculate an amount of time between inspections for the remaining operating lifetime by multiplying the remaining operating lifetime by a safety factor that is a variable from 10 percent to 90 percent of the remaining operating lifetime, and save the remaining operating lifetime as multiplied by the safety factor in the marine riser asset tracking model.

The data storage 14 can contain computer instructions 330 to instruct the processor to generate a timeline of inspection for the at least one marine riser asset using the remaining operating lifetime multiplied by the safety factor and save the timeline of inspection in the marine riser asset tracking model.

The data storage 14 can contain computer instructions 332 to instruct the processor to generate a schedule of repairs for the at least one marine riser asset by comparing the at least one event driven inspection of the at least one marine riser asset to the key performance indicators and save the schedule of repairs for the at least one marine riser asset in the marine riser asset tracking model.

The data storage 14 can contain computer instructions 330 to instruct the processor to present the remaining operating lifetime as multiplied by the safety factor for the at least one marine riser asset, the timeline of inspection, the schedule of repairs, and the marine riser asset tracking model to a client device connected to a network, as illustrated in box 334.

The disclosure shows a system for managing remaining operating lifetime for a plurality of marine riser assets simultaneously with customized units of time between necessary physical inspection and schedules of repair for individual marine riser assets, each marine riser asset having a geographic location and a zone of water depth.

The following is an example of the operation:

In embodiments, an asset profile is installed in a data storage connected to a processor further in communication with a network.

In embodiments, a marine riser asset tracking model with key performance indicators can be installed in the data storage connected to a processor.

The marine riser asset tracking model can be a plurality of computational computer instructions stored in the data storage that when used with the induction, inspection, risk assessment, and engineering assessment can create customized and unique inspection dates for particular marine risers at specific zones of water depth and take into account operating conditions which can be presented on a display.

In embodiments, a risk assessment 30 marine riser assets, which can be on a worldwide basis, is installed in the data storage.

In embodiments, an engineering assessment module 130 for marine riser asset, which can be on a worldwide basis, is installed in the data storage.

The engineering assessment can include lookup tables of degradation rates for marine riser assets.

An induction step is performed for at least one marine riser asset and linked to the owner profile.

### Example 1

Example 1 is a prophetic example to demonstrate how embodiments of systems and methods described herein could be implemented.

Induction

In embodiments, the induction of the invention can involve identifying and recording the physical and historic attributes of a marine riser asset and recording these within the marine riser asset tracking model. An induction can be performed on board a floating rig. As an example, for a marine riser asset, the induction can identify the marine riser asset as a 75 ft foot marine riser asset that will be deployed at depths up to 2,000 ft, in zone B of water depth according to the marine riser asset tracking model. In the induction, data gathering can take place, such as gathering of design data on the marine riser asset, which can include but is not limited to the riser dimensions, materials use for construction of the marine riser asset, physical properties of the material used on the marine riser asset, and lists of components attached to the marine riser asset.

During the induction, gathering of additional information on manufacturing occurs, including the gathering of data on location of manufacture, date of manufacture and manufacturer's serial number. Induction can include gathering ownership details and in some cases creating an asset profile. Other induction information can be linked to the asset profile in the marine riser asset tracking model.

As part of the induction, a machine readable identifier can be installed on the marine riser asset, such as an active RFID tag and be applied to a marine riser asset with a strap or adhesive, such as marine safe epoxy adhesive. Usable RFID tags are made by Technologies ROI LLC of Mauldin, S.C. Usable RFID tags can have a 96 Kb data capacity. A second optional sub step involves installing a QR code on the marine riser asset, via printing a label and adhering the label to the joint. The QR code is a passive tag.

Physical Inspection and Event Driven Physical Inspection

In embodiments, the physical inspection can be both visual inspection, and a non-destructive testing inspection using different non-destructive testing inspection systems to create physical inspection information for each marine riser asset. The physical inspection can include dimensional measuring of the marine riser and Ultrasonic Testing measurements.

In embodiments, the visual inspection of the marine riser asset can be performed by digital or analog devices, such as a visual image camera or an infrared camera, or even sonar, or a camera that records video images. Digital or analog visual inspection information can be uploaded to the marine riser asset tracking model in the data storage using the network.

In embodiments, one or more data storages can be used with the invention, in communication with each other. One or more processors can be used with the invention in communication with each other.

In embodiments, the visual inspection of the marine riser asset can be performed by a human, known as a “riser inspector” who has been trained to NDT level 2 qualifications according to ASTM standards. The riser inspector follows a written procedure for visual inspection of the marine riser asset that results in gathering an assessment of the condition of the riser that is identifying location of flaws, cracks, pittings, scratches and scores on the riser, and corrosion and noting these visual results in the marine riser asset tracking model on a computer with a wireless connection to the data storage containing the marine riser asset tracking model via a network.

The physical inspection for an exemplary 75 foot marine riser asset to be deployed in 2000 feet of water off a drilling rig can involve three different non-destructive testing inspections.

One of the non-destructive testing inspections can be an ultrasonic test for wall thickness such as determining whether the wall thickness is 0.75 inches including a recorded image of the wall thickness consisting of a plurality of individual measurements mapped together to provide a topography of the thickness of the pipe.

Another of the non-destructive testing inspection can be a magnetic particle physical inspection of welds in the marine riser asset, which would reveal for this joint that only 3 cracks exists which are each less than 0.025 of an inch deep and less than 1 inch in length in which the size of the cracks would not impede operation.

Still another of the non-destructive testing inspection can be a time of flight diffraction using Ultrasonic testing that confirms the magnetic particle section and records that confirmation as an image.

In embodiments, the non-destructive testing inspection results can be uploaded and transmitted automatically and wirelessly via the network from the testing devices to the marine riser asset tracking model for storage linked to the asset profile.

In embodiments, Physical inspection can involve making dimensional measurements on the marine riser asset using a measuring caliper or a laser measuring device or another automated measuring device, phased array robotic inspection tool, with the physical inspection results transmitted to the marine riser asset tracking model.

For example, for the 75 foot riser deployed in 2000 feet of water, the physical inspection could reveal an inner diameter of 5 inches with 5 boxes and an outer dimension 5.75 inches with 5 pins for attaching auxiliary lines and a main tube.

Baseline

In embodiments, a baseline for each marine riser asset can be created using the induction, physical inspection, engineering assessment, condition assessment and storing estimated life and next inspection date in the marine tracking model linked to the asset profile.

The marine riser asset tracking model can use the measured physical inspection data and identify a baseline operating condition using the initial measurements of the induction and physical inspection.

In embodiments, the baseline condition can be linked to the asset profile such as company Mantra Energy in the marine riser asset tracking model.

Also, the baseline condition can be linked to a specific rig such as the Deepwater Phoenix supporting the marine riser asset, the rig's geographic location in the Gulf of Mexico, and the zone of water depth at 2000 feet. Information on expected loop currents such as an expectation of a loop current of 3 knots for at least 4 days a year can be included in the baseline condition.

Assessment

In embodiments, the assessment can be stored within the marine raiser tracking model. The assessment can include key performance indicators, look up tables of degradation rates, an induction of the marine riser asset, physical inspections, a baseline for the marine riser asset, at least one of: a zone of water depth and components connected to the marine riser asset, both historic degradation rates and predictive degradation rates, operating conditions, anomalies and flaws, and event driven inspections.

In embodiments, assessment can be performed in the marine riser asset model 20 and linked to the asset profile, such as asset is located on rig name Rig GB007, owner Greenland Drilling, asset is assigned to Asset Pool number 3, located in Brazil, working on Well Timbuktu 33, for Operator Kaustubh Energy.

For Example for a marine riser, that is 7 years old, owned by Rig GB007, owner Greenland Drilling, asset is assigned to Asset Pool number 3, located in Brazil, working on Well Timbuktu 33, for Operator Kaustubh Energy, in zone water depth Z, where the anticipated operating conditions are recorded, the physical inspection may reveal 3 flaw, the maximum of which is 3 mm in size. The look up table shows that for the particular asset of the forgoing particulars, deployed in the forgoing operating conditions, the remaining operating lifetime is 12 years.

For example, if physical inspection results revealed degradation due to corrosion, the corrosion degradation is compared to information in the marine riser asset tracking model, and compared to the historic degradation rate, predicted degradation rate and the engineering assessment to determine an estimated remaining operating lifetime for this particular marine riser asset.

Historic Degradation Rates and Predictive Degradation Rates

In embodiments, predictive degradation rates can be determined by using calculations in the marine riser model that utilize physical inspection results from the non-destructive testing inspection of the marine riser asset and compare the physical inspection results to the engineering assessment and the preset limits of operating parameters while additionally calculating a remaining operating lifetime of the marine riser asset and the date of the next inspection.

For example, if corrosion was revealed in the ultrasonic test, then the ultrasonic test results can be compared to the previous ultrasonic tests in the marine riser asset tracking model, comparing the two measurements and the time elapsed in between the two inspections provides the historic degradation rate. The historic degradation rate together with the predictive degradation rate and standards in the industry are used to determine the remaining operating lifetime. Then the next inspection date of the marine riser asset can be calculated using industry standard API-RP-2RD, which could be 50 percent less of the remaining operating lifetime, enabling varying of the physical inspection frequency of the tubular for corrosion depending on the condition of the marine riser asset.

Operating Conditions Around the Marine Riser Asset and Anomalies

In embodiments, the marine riser asset tracking model can contain records of key performance indicators and compare the key performance indicators to the physical inspection of the marine riser asset.

In embodiments, the operating conditions around the marine riser asset can include wave height, current, riser tension, mud weight, riser angle, engineering assessment and physical inspection results.

In embodiments, the marine riser asset tracking model can provide an alarm when the compared operating conditions exceed or fall below the key performance indicators for operating conditions.

For example, if the operating condition of the marine riser asset shows a mud weight of 19 ppg compared to a key performance indicator of 15 ppg, then an alarm can be sent by the marine riser asset tracking model to a client device indicating the operating condition had exceeded the preset limits.

In embodiments, a zone of water depth and a geographic location can be included as an operating condition.

Condition of the Marine Riser Asset

In embodiments, the marine riser asset can be periodically inspected for at least one of: a visual inspection, a non-destructive testing inspection and dimensional measurements to verify a condition.

In embodiments, the condition of the marine riser asset can be determined through at least one event driven physical inspection that is at least one of: a baseline physical inspection, an annual physical inspection, an ad hoc physical inspection, and an updated baseline physical inspection.

In embodiments, the condition of the marine riser asset can be better than a baseline, the same as the baseline or worse than the baseline. The condition can include a one or more anomalies if they exist on the marine riser asset, as well as operating conditions surrounding the marine riser asset. In embodiments, the condition is saved in marine riser asset tracking model linked to the asset profile.

Remaining Operating Lifetime

In embodiments, a remaining operating lifetime for each marine riser asset with a zone of water depth and a baseline can be computed by a riser engineer. A riser engineer uses the engineering assessment, the historic degradation rate, the predictive degradation rate, the operating condition, the anomalies, and the conditions and computes a remaining operating lifetime for a marine riser asset tracking model.

Amount of Time Between Inspection

In embodiments, the amount of time between inspections for the remaining operating lifetime is computed using computer instructions in the marine riser asset tracking model and then saved in the marine riser asset tracking model.

In embodiments, the condition of the marine riser asset as determined using visual inspection, non-destructive-test physical inspection and dimensional measurements, the risk assessment, the engineering assessment, the zone of water depth for the marine riser asset, and the operating condition for marine riser assets, can be used to determine the degradation rate and the remaining operating lifetime. A safety factor from 10 percent to 90 percent is applied to the remaining operating lifetime to calculate the time between inspections.

For example, if the remaining operating lifetime for the marine riser asset is 15 years, then an amount of time between physical inspections will be computed using a safety factor of 50 percent, which is based on the engineering assessment for this marine riser using the operating conditions, conditions, assessment, inspections and baseline, causing the physical inspection of this marine riser asset to occur every 7 years.

Mapping of Key Performance Indicators

In embodiments, physical inspection results can be mapped to key performance indicators in the marine riser asset tracking model to provide a timeline of inspection and a schedule of repairs for each marine riser asset and saving the mapped information into the marine riser asset tracking model.

For example, when the physical inspection results indicate that the dimensions of the marine riser asset has changed due to impact, such that a gouge of 0.010 of an inch on the pin of the marine riser asset, and the gouge is larger than acceptable gouges indicated in the key performance indicator, then a schedule of needed repairs is generated.

### Example 2

Example 2 is a prophetic example to demonstrate how embodiments of systems and methods described herein could be implemented.

The following is an example of the steps of the system for a 50 foot marine riser asset with a design life of 30 years that is owned by Alpha Omega. The 50 foot marine riser asset is 7.5 years old and has a service history of 7 years and has a current valid certificate for 5 years. The 50 foot marine riser asset was deployed in Zone A in zones of water depth of 500 ft, for the operator, Cotton Industries, at well Bourbon 3, located in operating region of the Gulf of Mexico in 3200 foot water depth. The drilling facility is a semisubmersible named North Star. The 50 foot marine riser asset is certified fit for use according to the last baseline inspection on Apr. 3, 2015 and it has an baseline inspection frequency of 7 years and an annual visual inspection frequency of 1 year. The next baseline inspection is not due until April 2022. The annual visual is performed before Apr. 2, 2016. The steps of the process and the results thereof are covered in this example of the steps of the system:

Induction

The induction step of the system can involve performing an induction on board a floating rig for a 50 foot marine riser asset that will be deployed at 500 feet in zone A. The induction for example can include gathering design data on the marine riser asset including dimensions, weld details, material used to make the riser, physical properties of material and lists of components. The induction can include gathering manufacturing data including location of manufacture, date of manufacture, manufacture's serial number. The induction can include gathering ownership details and in some cases creating an asset profile. Further examples of data collected in this phase can include values such as; 30 years design life and X-80 carbon steel material and serial number 569874123.

Installing

The install step can involve attaching first as a sub step a machine readable identifier, such as an active RFID tag, on the marine riser asset with a strap or adhesive, such as marine safe epoxy adhesive. Usable RFID tags are made by Technologies ROI LLC of Mauldin, S.C. Usable RFID tags can have a 128 Kb data capacity. A second sub step involves installing a QR code on the marine riser asset, via printing a label and adhering the label to the joint. The QR code is a passive tag. During this step, the 50 foot marine riser asset will be given a unique identifier, such as RFID No. 1001000000000000000A0132. The identification code, 1001000000000000000A0132, will be input into the marine riser asset tracking model and all inspections, operations, repairs and maintenance will be tracked against this identifier.

Inspection by Visual Inspection and by Non-Destructive Testing Inspection

The inspection for the 50 foot marine riser asset only requires a visual inspection and does not require non-destructive testing inspection, because the last inspection performed was on Apr. 3, 2015 and results of the inspection gave the non-destructive testing inspection a frequency of 7 years, which means it is not due until April 2022. The visual inspection however is before Apr. 2, 2016 and is a two-step process and the steps are:

The visual inspection of the marine riser asset is performed by both a digital screening device, that is video and static images, which are uploaded to a marine riser asset tracking model in administrative data storage using the network according to the RFID# 1001000000000000000A0132.

The visual inspection of the marine riser asset can also performed by a human, known as a “riser inspector” who has been trained to NDT level 2 qualifications according to ASTM standards. The riser inspector follows a written procedure for visual inspection of the marine riser asset that results in gathering an assessment of the condition of the riser, that is observing the location of flaws, cracks, pittings, scratches and scores on the riser, and corrosion and noting these visual results in the marine riser asset tracking model on his laptop with a wireless connection to the administrative data storage containing the marine riser asset tracking model via a network.

The Establishment of a Baseline Condition

The marine riser asset tracking model can establish a baseline condition using the measured inspection data as initial measurements of the riser as the baseline against which future measurements can be compared. The baseline condition can be established from the induction and inspection steps. The baseline condition can be linked to an asset profile and owner such as Alpha Omega in the marine riser asset tracking model. The baseline condition can also be linked to the specific rig such as the North Star semisubmersible supporting the marine riser asset, NOWY-RISE 403, for the rig geographic location in the Gulf of Mexico and is operating for Cotton Industries' well, Bourbon 3, in 3200 feet water depth. The 50 foot riser marine riser asset can be deployed at the zones of water depth at 500 feet in Zone A and is not expecting current above 1.5 knots during drilling operations.

Creating an Operational Assessment of the Remaining Operating Lifetime of this 500 Foot Operating Depth in Zone A for the 50 Foot Riser Marine Riser Asset Used at the North Star Semisubmersible for Cotton Industries.

Step 1 can include comparing inspection results to information in the marine riser asset tracking model and to information in lookup tables of degradation rates of the marine riser assets to determine an estimated remaining operating lifetime for this particular marine riser asset forming a remaining operating lifetime assessment for the marine riser asset.

Step 2 can include comparing the remaining operating lifetime assessment to the engineering assessment to determine if the condition of the marine riser asset is changing at a faster or slower rates that anticipated in the engineering assessment.

For example, if inspection results revealed excessive corrosion, the extent of the corrosion can be compared to information in the marine riser asset tracking model, and to look up tables of degradation rates to determine an estimated remaining operating lifetime for this particular marine riser asset.

Calculate Historic and Predictive Degradation Rates of the Marine Riser Asset

The inspection results from the non-destructive testing inspection of the marine riser asset can be compared to the lookup tables of degradation rates of the marine riser assets to determine if the marine riser asset is within preset limits for operating parameters and additionally calculate remaining operating lifetime of the marine riser asset.

For example, if corrosion was revealed in the ultrasonic test, then the ultrasonic test results' thickness is compared to the thickness test on the look up table to provide a remaining operating lifetime and then calculate time between inspections using a safety factor, which can be 50 percent less of the remaining operating lifetime, enabling altering of the inspection frequency of the tubular for corrosion.

Monitoring Operating Data and Anomalies for Marine Riser Assets

The marine riser asset tracking model can compare the key performance indicators to the inspection results of the marine riser asset and provide an alarm when the inspection results exceed or fall below the key performance indicators showing an anomaly.

For example, if the test results for the marine riser asset shows a crack as an anomaly on the joint was 1.2 inches and in accordance with the key performance indicator the cracks in welds was not to exceed 1.0 inch. The marine riser asset tracking model can send an alarms to a client device indicating the corrosion has exceeded the preset limits.

The marine riser asset tracking model can compares the key performance indicators to the operating condition of the marine riser asset and provide an alarm when the compared operating condition exceeds or falls below the key performance indicators for operating condition.

For example, if the operating condition of the marine riser asset shows the rig moved from the Gulf of Mexico to South East Asia then an alarms would be sent by the marine riser asset tracking model to a client device indicating the operating condition had alerted a change in environmental conditions which can possibly exceeded the preset environmental conditions limits and will require further engineering assessment.

Verify the Condition

The marine riser asset can be periodically pulled from the sea and then visually inspected on deck and optionally inspected via a non-destructive testing inspection on deck to verify an anticipated condition and performing a remaining operating lifetime analysis for the marine riser asset.

Calculating an Amount of Time Between Inspections

If the remaining operating lifetime prediction for the 50 foot marine riser asset is 20 years, then the amount of time between inspections will be computed using a safety factor in this example 40 percent, causing the inspections of this marine riser asset to occur every 8 years.

The inspection results within the marine riser asset tracking model are compared to the engineering assessment to determine when repairs to the marine riser asset will be required and the extent of the repairs required.

When the inspection results of the marine riser asset indicate that the dimensions of the marine riser asset have changed due to, for example, incorrect coupling resulting in a damaged box end component, such that the connection between the box and pin can no longer connect and seal safely, then a repair ticket will be generated and the marine riser asset will be transferred to the repair vendor to fix the marine riser.

### Example 3

Example 3 is a prophetic example to demonstrate how embodiments of systems and methods described herein could be implemented.

The following is an example of the steps of a system that has a 65 foot marine riser asset with a design life of 25 years that is owned by Ashka Energy. The 65 foot marine riser asset can be 15 years old and have a service history of 10 years. The 65 foot marine riser asset could be deployed in Zone C in a zone of water depth of 3,850 ft, for the operator, Tanisha Enterprise, at well SS#445, located in operating region of the West Africa—Angola in 3200 ft water depth. The drilling facility can be a drillship named True depth. The 65 ft marine riser asset could be certified fit for use according to the last inspection on Jan. 28, 2010 and have an inspection frequency of 6 years. This example covers the required inspection that would be performed on Jan. 2, 2016. The steps of the process and the results thereof are covered in this example of the steps of the system:

Induction

The induction step of the system can involve performing an induction at the storage yard in Angola for a 65 foot marine riser asset that will be later deployed at 3,850 feet in Zone C. The induction for example can include gathering design data on the marine riser asset including ancillary line, weld details, material used to make the joint, physical properties of material and lists of components. The induction can include gathering manufacturing data including location of manufacture, date of manufacture, manufacture's name and address. The induction can include gathering ownership details and in some cases creating an asset profile. Further examples of data collected in this phase can include values such as; 25 years design life and carbon steel material.

Installing

The install step involves attaching first, as a sub step, a machine readable identifier, such as an active RFID chip or tag, on the marine riser asset with a strap or adhesive, such as marine safe epoxy adhesive. Usable RFID tags are made by INFOCHIP™ of Houston, Tex. Usable RFID tags can have a 128 Kb data capacity. A second sub step involves installing a QR code on the marine riser asset, via printing a label and adhering the label to the joint. The QR code is a passive tag. During this step, the 65 foot marine riser asset will be given a unique identifier, such as RFID No. ASH-RISE321. The identification code, ASH-RISE321, will be input into the marine riser asset tracking model and all inspections, operations, repairs and maintenance will be tracked against this identifier.

Inspection by Visual Inspection and by Non-Destructive Testing Inspection

The inspection for the 65 foot marine riser asset, ASH-RISE321, requires a visual inspection, dimension check and non-destructive testing inspection. The visual inspection is a two-step process and the steps are as follows.

The visual inspection of the marine riser asset can be performed by a digital imaging device, which can be any digital imaging device known in the industry, that has video and static images, which can be uploaded to a marine riser asset tracking model in administrative data storage using the network according to the RFID No. ASH-RISER321.

The visual inspection of the marine riser asset can also be performed by a human, known as a “riser inspector” who has been trained to NDT level 2 qualifications according to ASTM standards. The riser inspector follows a written procedure for visual inspection of the 65 foot marine riser asset that results gathering assessment of the condition of the riser, that is identifying location of flaws, cracks, pittings, scratches, and scores on the riser, and corrosion and noting these visual results in the marine riser asset tracking model with his/her laptop with a wireless connection to the administrative data storage containing the marine riser asset tracking model via a network.

The inspection step for this 65 foot marine riser asset can involve three non-destructive testing inspections including (1) an ultrasonic test for wall thickness such as determining the minimum wall thickness is 0.723 inches including a recorded image of the wall thickness, which reveals for this joint that the wall loss of the joint is 0.027 of an inch of the designed wall thickness of 0.75 of an inch, wherein the size will not impede operation, (2) a phased array inspection of welds in the marine riser asset; and (3) a time of flight diffraction (TOFD) that complements the phased array inspection and records both phased array and TOFD as an image. Typically, the riser inspector will transmit the non-destructive-test results to the marine riser asset tracking model.

The inspection step involves dimension checks on the marine riser asset using a caliper or laser measuring device with the riser inspector transmitting the measured dimension to the marine riser asset tracking model. This particular marine riser asset can be measured for the inner diameter of the 5 boxes, outer dimension of the 5 pins of the marine riser asset auxiliary lines and main tube and surface finishes of seal areas. All measurements from the inspection are within 0.0003 inches of the design parameters and therefore will not impede operation. The measured dimensions can be transmitted to the marine riser asset tracking model.

The Establishment of a Baseline Condition

The marine riser asset tracking model using the measured inspection data identifies a baseline condition using the initial measurements of the induction and inspection steps. The baseline condition can be linked to an asset profile such as Tanisha Enterprise in the marine riser asset tracking model. The baseline condition can also be linked to the specific rig such as the True depth Drillship supporting the marine riser asset, the rig geographic location in West Africa—Angola and the zone of water depth at 3,850 feet and the expected surface current is to be 0.7 knots with a significant wave height of 4 m.

Creating of an Operational Assessment of the Remaining Operating Lifetime of this 65 Foot Marine Riser Asset Used at SS#445 in Zone C at a Depth of 3,850 ft for the True Depth Drillship

Step 1 can include comparing inspection results to information in the marine riser asset tracking model and to information in lookup tables of degradation rates of the marine riser assets to determine an estimated remaining operating lifetime for this particular marine riser asset forming a remaining operating lifetime assessment for the marine riser asset.

Step 2 can include comparing the remaining operating lifetime assessment to the engineering assessment to determine if the condition of the marine riser asset is changing at a faster or slower rates that anticipated in the engineering assessment.

For example, if inspection results revealed an erosion issue, the erosion issue can be compared to information in the marine riser asset tracking model, and to look up tables of degradation rates to determine an estimated remaining operating lifetime for this particular marine riser asset.

Calculate Historic and Predictive Degradation Rates of the Marine Riser Asset

In embodiments, inspection results from the non-destructive testing inspection of the marine riser asset can be compared to the lookup tables of degradation rates of the marine riser assets to determine if the marine riser asset is within preset limits for operating conditions, determine the new rate of degradation and using both these inputs calculate remaining operating lifetime of the marine riser asset.

For example, if erosion was revealed in the ultrasonic test, then the ultrasonic test results can be compared to ultrasonic test on the look up table to provide a remaining operating lifetime, the new test results can also be compared to the previous test results to evaluate the new degradation rate. Then, the remaining operating lifetime of the marine riser asset can be calculated using a combination of the predicted degradation rate, the previous degradation rate, the new degradation rate and the safety factor, which could be 45 percent less of the remaining operating lifetime, enabling altering of the inspection frequency of the tubular for corrosion.

Monitoring Operating Conditions and Anomalies for Marine Riser Assets

The marine riser asset tracking model can compare the key performance indicators to the inspection results of the marine riser asset and provides an alarms when the inspection results exceed or fall below the key performance indicators showing an anomaly.

For example, if the test results for the marine riser asset showing erosion as an anomaly on the joint was 0.065 inches and the key performance indicator said that corrosion was not to exceed 0.05 inches then the marine riser asset tracking model would send an alarms to a client device indicating the erosion had exceeded the preset limits.

The marine riser asset tracking model can compare the key performance indicators to the operating condition of the marine riser asset and provide an alarm when the compared operating condition exceeds or falls below the key performance indicators for operating condition.

For example, if the operating condition of the marine riser asset shows a current data of 5 knots compared to a key performance indicator of 4 knots, then alarms can be sent by the marine riser asset tracking model to a client device indicating the operating condition had exceeded the preset limits.

Verify the Condition

The marine riser asset can be periodically pulled from the sea and then visually inspected on deck and optionally inspected by non-destructive testing inspection on deck to verify an anticipated condition and performing a remaining operating lifetime analysis for the marine riser asset.

Calculating an Amount of Time Between Inspections

If the remaining operating lifetime prediction for the marine riser asset from the results of the inspection on Jan. 2, 2016 is 18 years, then the amount of time between inspections will be computed using a safety factor, in this case 45%, causing the inspections of this marine riser asset to occur every 8 years. This increases time between inspections from the previous frequency of 7 years to 8 years.

Comparing inspection results with the marine riser asset tracking model to the engineering assessment, to determine when repairs to the marine riser asset is required.

When the inspection results of the marine riser asset indicate that the dimensions of the auxiliary line pin connection 65 foot marine riser asset have changed due to, for example, impact, such that a scratch of 0.05 of an inch on the pin of the marine riser asset, and this scratch is larger than acceptable scratches indicated in the engineering assessment, then a repair ticket will be generated and transferred to the repair vendor to fix the marine riser.

In embodiments, the operating condition can include water states, water currents, wave heights, a likelihood of a severe storm, a duration of time for a marine riser asset in a plurality of operating modes and a zone of water depth for the marine riser asset, fluid weight of fluid passing through the marine riser asset, fluid chemistry for fluid passing through the marine riser asset, a temperature of fluid passing through the marine riser asset, and fluid pressure of fluid passing through the marine riser asset, riser tension load applied to the marine riser asset, and an angle of inclination of a marine riser asset and/or operating abnormalities for the marine riser asset as well as information on maintenance performed on components, a maintenance plan for flaws and a preventive maintenance the marine riser asset.

In embodiments, the machine readable identifier can be at least one of a radio frequency identification “RFID” chip, a bar code, and a quick response “QR” code.

In embodiments, zones of water depth can have priority grouping, which can be created using the predictive degradation rate.

While these embodiments have been described with emphasis on the embodiments, it should be understood that within the scope of the appended claims, the embodiments might be practiced other than as specifically described herein.

The embodiments help protect the integrity of individual marine riser assets and provide a safer operation of interdependent marine riser assets.

The embodiments can estimate and monitor the remaining safe operating lifetime of marine riser assets and an assembly of interdependent marine riser assets.

The embodiments can extend the amount of time between physical inspection based on risk assessment, condition of marine riser assets and operating conditions of the marine riser asset by tracking flaws and anomalies of marine riser assets.

The embodiments can reduce cost and time for repairs and reduce out of service time by monitoring the condition of the marine riser assets, the operating condition by tracking flaws and anomalies of marine riser assets.

The embodiments can organize a stack up deployment of connected marine riser assets by zones of water depth, thereby providing a distinction in the remaining operating lifetime of individual marine riser assets for different zones of water depth.

In embodiments, a user can be provided with alerts and alarms when conditions of the marine riser asset fall below or exceed pre-defined operating conditions or key performance indicators for individual marine riser assets.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

1. (canceled)

2. The computer program product of claim 3, wherein the program instructions are further executable by the computer to cause the computer to:
compare the first predictive degradation rate and the first actual degradation rate;
based on the first predictive degradation rate exceeding the first actual degradation rate, determine the first remaining operating lifetime of the riser asset based on the first predictive degradation rate and a baseline parameter; and
based on the first actual degradation rate exceeding the first predictive degradation rate, determine the first remaining operating lifetime of the riser asset based on the first actual degradation rate and the baseline parameter.

3. A computer program product for generating an inspection timeline for a riser asset of a marine riser comprising a computer readable storage medium having program instructions embodied therewith, the program instructions executable by a computer to cause the computer to:
receive a first predictive degradation rate of a first potential flaw in the riser asset;
receive a first actual degradation rate of a first flaw in the riser asset, the first flaw corresponding with the first potential flaw;
determine a first remaining operating lifetime of the riser asset based on the first predictive degradation rate and the first actual degradation rate;
determine an inspection frequency for the riser asset based on a safety factor and the first remaining operating lifetime of the riser asset; and
generate the inspection timeline based on the inspection frequency; and
multiply the safety factor with the first remaining operating lifetime of the riser asset to determine the inspection frequency.

4. The computer program product of claim 3, wherein the safety factor is between 10 percent and 90 percent.

5. The computer program product of claim 3, wherein the program instructions are further executable by the computer to cause the computer to:
receive a second predictive degradation rate of a second potential flaw in the riser asset;
receive a second actual degradation rate of a second flaw in the riser asset, the second flaw corresponding with the second potential flaw; and
determine a second remaining operating lifetime of the riser asset based on the second predictive degradation rate and the second actual degradation rate.

6. The computer program product of claim 5, wherein the program instructions are further executable by the computer to cause the computer to:
compare the first remaining operating lifetime with the second remaining operating lifetime;
based on the first remaining operating lifetime being less than the second remaining operating lifetime, determine the inspection frequency for the riser asset based on the safety factor and the first remaining operating lifetime of the riser asset; and
based on the second remaining operating lifetime being less than the second remaining operating lifetime, determine the inspection frequency for the riser asset based on the safety factor and the second remaining operating lifetime of the riser asset.

7. The computer program product of 3, wherein the first flaw is a crack in the riser asset or corrosion in the riser asset.

8. (canceled)

9. (canceled)

10. (canceled)

11. (canceled)

12. (canceled)

13. (canceled)

14. (canceled)

15. (canceled)

16. (canceled)

17. (canceled)

18. The marine riser inspection system of claim 20, further comprising a first sensor configured to detect the first flaw and transmit data indicative of the first flaw to the operational assessment module.

19. The marine riser inspection system of claim 20, wherein the operational assessment module is further configured to:
compare the first predictive degradation rate and the first actual degradation rate;
based on the first predictive degradation rate exceeding the first actual degradation rate, determine the first remaining operating lifetime of the riser asset based on the first predictive degradation rate and a baseline parameter; and
based on the first actual degradation rate exceeding the first predictive degradation rate, determine the first remaining operating lifetime of the riser asset based on the first actual degradation rate and the baseline parameter.

20. A marine riser inspection system, comprising:
a riser asset; and
an operational assessment module configured to:
receive a first predictive degradation rate of a first potential flaw in the riser asset;
receive a first actual degradation rate of a first flaw in the riser asset, the first flaw corresponding with the first potential flaw;
determine a first remaining operating lifetime of the riser asset based on the first predictive degradation rate and the first actual degradation rate;
determine an inspection frequency for the riser asset based on a safety factor and the first remaining operating lifetime of the riser asset; and
generate the inspection timeline based on the inspection frequency;
wherein the operational assessment module is further configured to multiply the safety factor with the first remaining operating lifetime of the riser asset to determine the inspection frequency.

21. The marine riser inspection system of claim 20, wherein the operational assessment module is further configured to:
receive a second predictive degradation rate of a second potential flaw in the riser asset;
receive a second actual degradation rate of a second flaw in the riser asset, the second flaw corresponding with the second potential flaw; and
determine a second remaining operating lifetime of the riser asset based on the second predictive degradation rate and the second actual degradation rate.

22. The marine riser inspection system of claim 21, wherein the operational assessment module is further configured to:
compare the first remaining operating lifetime with the second remaining operating lifetime;
based on the first remaining operating lifetime being less than the second remaining operating lifetime, determine the inspection frequency for the riser asset based on the safety factor and the first remaining operating lifetime of the riser asset; and
based on the second remaining operating lifetime being less than the second remaining operating lifetime, determine the inspection frequency for the riser asset based on the safety factor and the second remaining operating lifetime of the riser asset.
